(19) United States
(12) Patent Application Publication
(10) Pub. No.: US 2024/0110012 A1
(43) Pub. Date: Apr. 4, 2024

(54) THERMALLY CROSSLINKABLE LIQUID-CRYSTALLINE CO-POLYIMIDES DERIVED FROM WHOLLY AROMATIC DIAMINES AND MULTIPLE MESOGENIC DIANHYDRIDES AND THEIR CROSSLINKED PRODUCTS THEREFROM

(71) Applicant: Government of the United States, as represented by the Secretary of the Air Force, Wright-Patterson AFB, OH (US)

(72) Inventors: Loon-Seng Tan, Centerville, OH (US); Zhenning Yu, Beavercreek, OH (US)

(21) Appl. No.: 18/299,096

(22) Filed: Apr. 12, 2023

Related U.S. Application Data
(60) Provisional application No. 63/406,009, filed on Sep. 13, 2022.

(51) Int. Cl. C08G 73/10

(52) U.S. Cl. CPC C08G 73/1071

(57) ABSTRACT

Crosslinkable, low-molecular-weight, main-chain thermotropic liquid-crystalline co-polyimides derived from the polycondensation of (i) liquid-crystallinity-enabling, wholly aromatic and flexible diamine monomers, in which the linkage between the two aniline-ends contains a relatively high heat-tolerant but flexible chain constituted by multiple phenoxy (MP) moieties, i.e., two or more units of 1,4-phenoxy or 1,3-phenoxy or in combinations of both. Such polyimides allow the modification of ink materials to meet varying processing conditions in additive manufacturing of devices and components that require high-temperature polymers.

### CROSS-REFERENCE TO RELATED APPLICATION

The present application claims priority to U.S. Provisional Application Ser. No. 63/406,009 filed Sep. 13, 2022, the contents of which is hereby incorporated by reference in their entry. The present application is related to, but does not claim priority to, U.S. application Ser. No. 14/999,921 which was filed under a secrecy order on Jan. 25, 2017.

### RIGHTS OF THE GOVERNMENT

The invention described herein may be manufactured and used by or for the Government of the United States for all governmental purposes without the payment of any royalty.

### FIELD OF THE INVENTION

The present invention relates to crosslinkable, low-molecular-weight, main-chain thermotropic liquid-crystalline co-polyimides and methods of making and using same.

### BACKGROUND OF THE INVENTION

Applicants disclose compositions of and methods of manufacture for a family of low-molecular-weight, main-chain thermotropic liquid-crystalline co-polyimides (TLC-CoPI) that are crosslinkable and derived from the polycondensation of (i) liquid-crystallinity-enabling, wholly aromatic and flexible diamine monomers, in which the linkage between the two aniline-ends contains a relatively high heat-tolerant but flexible chain constituted by multiple phenoxy (MP) moieties, i.e., two or more units of 1,4-phenoxy or 1,3-phenoxy or in combinations of both. These bis(aniline) or di-aniline monomers are designated as MPDA, and the diketo-(K) containing MPDA derivatives are further designated as MPKDA, (ii) two or more mesogenic dianhydrides, at least one of which is a di(phthalic danhydride) or DPA that contains one or more thermally reactive and crosslinkable moieties similar to that of phenylethynyl (PE), and (iii) endcapped with aromatic groups that can be either thermally reactive or inert to PE crosslinking reactions, such as phthalic anhydride (PA) or thermally reactive one such as 4-phenylethynylanhydride (PEPA). A thermally non-crosslinkable mesogenic dianhydride can be pyromellitic dianhydride (PMDA), terphenyl dianhydride (TPDA) or a combination of both. The feature of copolymer composition has the advantage of being flexible in modifying the ink materials to meet varying processing conditions in additive manufacturing of devices and components that require high-temperature polymers.

### SUMMARY OF THE INVENTION

Crosslinkable, low-molecular-weight, main-chain thermotropic liquid-crystalline co-polyimides derived from the polycondensation of (i) liquid-crystallinity-enabling, wholly aromatic and flexible diamine monomers, in which the linkage between the two aniline-ends contains a relatively high heat-tolerant but flexible chain constituted by multiple phenoxy (MP) moieties, i.e., two or more units of 1,4-phenoxy or 1,3-phenoxy or in combinations of both. Such polyimides allow the modification of ink materials to meet varying processing conditions in additive manufacturing of devices and components that require high-temperature polymers.

Additional objects, advantages, and novel features of the invention will be set forth in part in the description that follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts the structural comparisons of (a) an asymmetric phthalimide-ester (PIE) mesogen and (b) the symmetrical pyromellitimide, PMDI and linked diphthalic dianhydride (LDPA). and (in boxes) the corresponding repeat units in their polyimides that are liquid crystalline (LC) or non-LC. The linking group (L) is generally a short linker and the wavy symbol represent flexible chains such as (CH₂)ₙ, —(CH₂CH₂O)ₙ—. BACB is a highly aromatic and flexible linker derived from the diamine, 1,3-bis[4′-(4″-aminophenoxy)cumyl)]benzene.

FIG. 2 depicts the structures and coding of “multiple phenoxy di-aniline” (MPDA) and “multiple phenoxy di-keto di-aniline” (MP diamines).

FIG. 3 depicts the integrated synthetic scheme for the LC-enabling MPDA diamines

FIG. 4 depicts some examples of Reactive and Non-reactive Mesogenic Dianhydrides (R-DPA & NR-DPA).

FIG. 5. An integrated scheme for the design and synthesis of new mesogenic dianhydrides, R-DPA's: (i) PE-DPA (ii) EPE-DPA (iii) EFPE-DPA and (iv) EPPE-DPA. The dianhydrides EDPA (ethynyl-linked) and PDPA (paraphenylene-linked; same as TPDA) are known compounds). 1,3EPE-DPA is a new dianhydride and synthesized to demonstrate the adverse effect of kink on the dianhydride mesogenicity

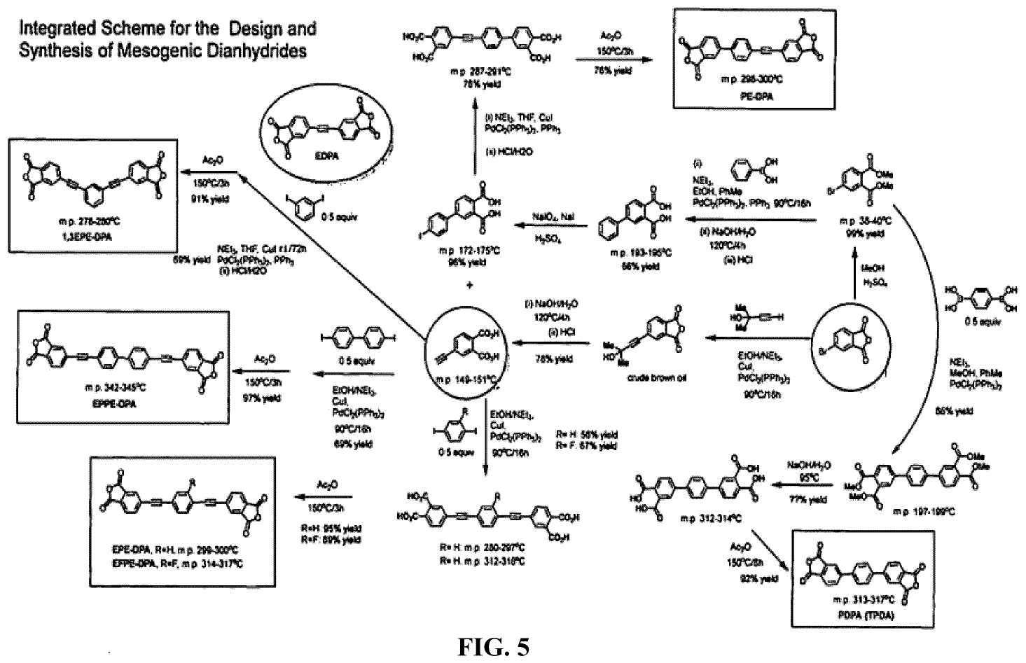

FIG. 6 depicts the general scheme for the syntheses of (i) phthalic anhydride (PA) endcapped and (ii) 4-phenylethynylphthalic anhydride (PEPA)-endcapped LC co-polyimides (i-a) PA-[MPDA-L′(DPA)]ₚ- [MPDA-L″(DPA)]_{q}-PA, (i-b) PA-[MPKDA-L′(DPA)]ₚ- [MPKDA-L″(DPA)]_{q}-PA, and (ii-a)) PEPA-[MPDA-L′(DPA)]ₚ- [MPDA-L″(DPA)]_{q}-PEPA, (ii-b) PEPA-[MPKDA-L′(DPA)]ₚ- [MPKDA-L″(DPA)]q-PEPA.

FIG. 7A depicts structural representations for the chemical compositions of the crosslinkable, thermotropic liquid-crystalline co-polyimides prepared according to the stoichiometric ratios of two dianhydrides, a common diamine, and an endcapping agent as shown in Table 3.

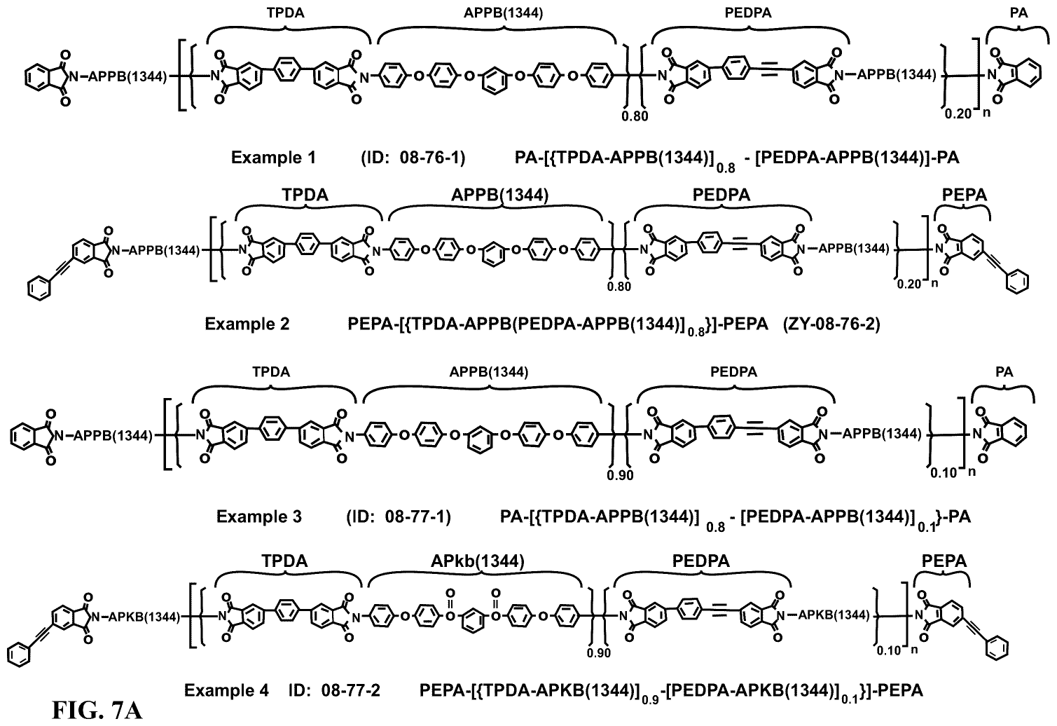

FIG. 7B depicts structural representations for the chemical compositions of the crosslinkable, thermotropic liquid-crystalline co-polyimides prepared according to the stoichiometric ratios of two dianhydrides, a common diamine, and an endcapping agent as shown in Table 3.

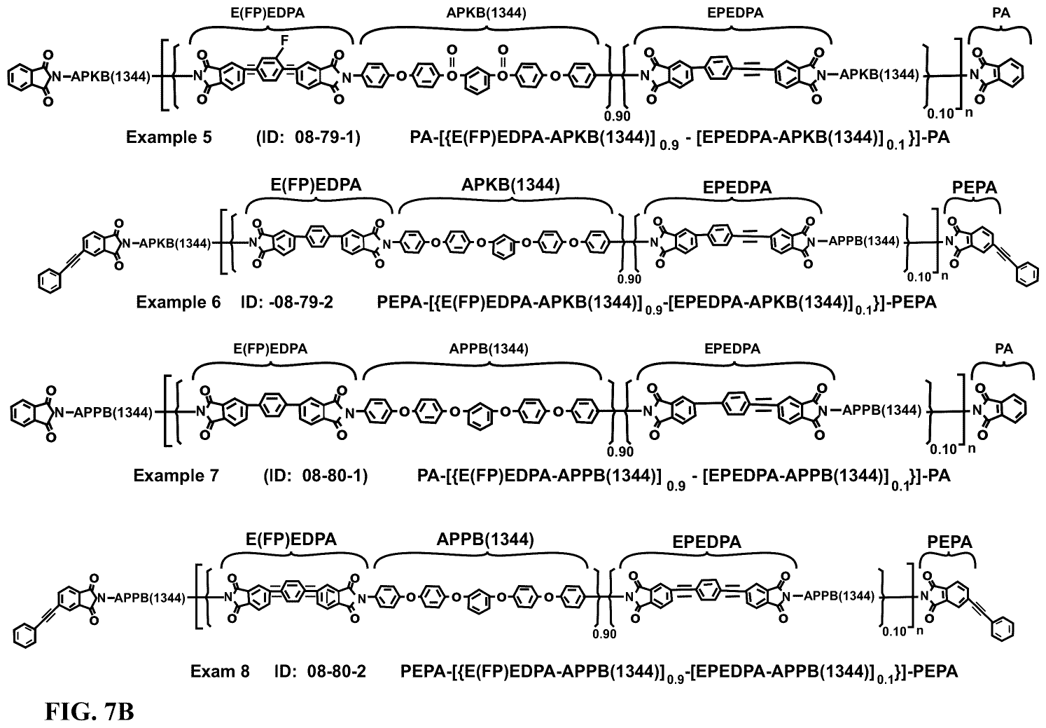

FIG. 8 depicts (a) first DSC heating scan (red) of 08-76-1 up to 475° C., which shows glass transition and crosslinking related exothermal peaks, and second DSC heating scan up to 400° C., showing the glass transition of the crosslinked product; (b) the heating and cooling traces between 50 and 360° C. of 08-76-1, revealing the glass transition and the “liquid-crystalline-phase to isotropic-phase” transition of PA-endcapped, crosslinkable copolyimide 08-76-2; (c) POM micrographs of 08-76-1 taken when cooling from isotropic melt state at (from top to bottom) 310° C., 304° C., and 300° C.

FIG. 9 depicts (a) first DSC heating trace of copolyimide 08-76-2 from r.t. to 475° C., revealing the initial glass transition (Tᵢₙᵢ) and possibly crosslinking-related exothermal peaks and second heating trace from r.t. to 400° C., showing the glass transition (T_{g,cured}) of crosslinked product; (b) DSC heating and cooling traces in the 50-360° C. region, showing the glass-transition, and the “liquid crystalline phase to isotropic phase” transition of PEPA-endcapped, crosslinkable copolyimide 08-76-2; (c) the hot-staged POM micrographs of 08-76-2 taken when cooling from its isotropic melt (top to bottom) at 317° C., 312° C., and 305° C.

FIG. 10 depicts (a) the first DSC heating curve of copolyimide 08-77-1 from r.t. to 475° C., to reveal the initial glass transition (T_{g,ini}) and crosslinking-related exothermal peaks. Second heating from r.t. to 400° C. to show the glass transition (T_{g⋅cured}) of the crosslinked product; (b) DSC heating and cooling curves in the 50-360° C. region, showing the glass transition and the “liquid crystalline phase to isotropic phase” transition of PEPA-endcapped, crosslinkable copolyimide 08-77-1; (c) the hot-staged POM pictures of 08-77-1 cooling from its isotropic melt (top to bottom) at 326° C., 324° C. and 320° C.

FIG. 11 depicts (a) the first DSC heating curve of copolyimide 08-77-2 from r.t. to 475° C., revealing the initial glass transition (T_{g,ini}) and crosslinking-related exothermal peaks, and the second heating scan from r.t. to 400° C., revealing the glass transition (T_{g,cured}) of the crosslinked product; (b) DSC heating and cooling curves in the 50-360° C. region, revealing the glass transition and the “liquid crystalline phase to isotropic phase” transition of PEPA-endcapped, crosslinkable copolyimide 08-77-2; (c) the hot-staged POM pictures of 08-77-2 cooling from its isotropic melt (top to bottom) at 345° C., 342° C. and 325° C.

FIG. 12 depicts (a) the first DSC heating trace of copolyimide 08-79-1 from r.t. to 475° C., revealing the initial glass transition (T_{g,ini}) and crosslinking-related exothermal peaks and the second heating from r.t. to 400 ° C., revealing the glass transition (T_{g,cured}) of the crosslinked product; (b) DSC heating and cooling traces in the 0-350° C. region, revealing the glass transition and the “liquid crystal to isotropic phase” transition of the copolyimide 08-79-1; (c) hot-staged POM micrographs of 08-79-1 taken when cooling from its isotropic melt (top to bottom) at 360° C., 350° C., and 340° C.

FIG. 13 depicts (a) the first DSC heating curve of copolyimide 08-79-2 from r.t. to 475° C. to reveal the initial glass transition (T_{g,ini}) and the crosslinking-related exothermal peaks, and the second heating from r.t. to 400° C. to reveal the glass transition (T_{g,cured}) of the crosslinked product; (b) DSC heating and cooling curves in the 0-350° C. region to reveal the glass transition and the “liquid crystal to isotropic phase” transition of PEPA-endcapped, crosslinkable copolyimide 08-79-2; (c) the hot-staged POM pictures of 08-79-2 cooling from its isotropic melt (top to bottom) at 360° C., 350° C. and 340° C.

FIG. 14 depicts (a) the first DSC heating curve of copolyimide 08-80-1 from r.t. to 475° C. to reveal the initial glass transition (T_{g,ini}) and the crosslinking-related exothermal peaks, and the second heating from r.t. to 400° C. to reveal the glass transition (T_{g,cured}) of the crosslinked product; (b) the DSC heating and cooling curves in the 0-360° C. region to show the glass transition and the “liquid crystalline phase to isotropic phase” transition of the PA-endcapped, crosslinkable copolyimide 08-80-1; (c) the hot-staged POM pictures of 08-80-1 cooling from its isotropic melt (top to bottom) at 360° C., 350° C. and 340° C.

FIG. 15 depicts (a) the first DSC heating trace of copolyimide 08-80-2 scanning from r.t. to 475° C., to reveal the initial glass transition (Tᵢₙᵢ) and the crosslinking-related exothermal peaks, and the second heating from r.t. to 400° C. to reveal the glass transition (T_{g,cured}) of the crosslinked product; (b) the DSC heating and cooling traces in the 0-350° C. region to show the glass transition and the “liquid crystalline phase to isotropic phase” transition of the PEPA-endcapped, crosslinkable copolyimide 08-80-1; (c) the hot-staged POM pictures of 08-80-1 cooling from its isotropic melt (top to bottom) at 360° C., 350° C. and 340° C.

FIG. 16 depicts the chemical structure of copolyimide 08-76-1, and photo of the fiber pulled from its melt at 250° C.

FIG. 17 depicts the chemical structure of copolyimide 08-76-2, and photo of the fiber pulled from its melt at 260° C.

FIG. 18 depict the chemical structure of copolyimide 08-77-1, and photo of the fiber pulled from its melt at 280° C.

FIG. 19 depict the chemical structure of copolyimide 08-77-2, and photo of the fiber pulled from its melt at 280° C.

### DETAILED DESCRIPTION OF THE INVENTION

### Definitions

Unless specifically stated otherwise, as used herein, the terms “a”, “an” and “the” mean “at least one”.

As used herein, the terms “include”, “includes” and “including” are meant to be non-limiting.

As used herein, the words “about,” “approximately,” or the like, when accompanying a numerical value, are to be construed as indicating a deviation as would be appreciated by one of ordinary skill in the art to operate satisfactorily for an intended purpose.

As used herein, the words “and/or” means, when referring to embodiments (for example an embodiment having elements A and/or B) that the embodiment may have element A alone, element B alone, or elements A and B taken together.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

DPA is the abbreviation for Di-(Phthalic Dianhydride) or diphthalic dianhydride.

DSC is the abbreviation for Differential scanning caloriemetry.

EDPA is the abbreviation for compound with a chemical name of “ethynyl-4,4′-di(phthalic anhydride).”

EFPE-DPA is the abbreviation for compound with a chemical name of “4,4′-(2-fluoro-1,4-phenylene)bis(ethyne-2,1-diyl)diphthalic anhydride.”

1,4EPE-DPA is the abbreviation for compound with a chemical name of “4,4′-(1,4-phenylenebis(ethyne-2,1-diyl))diphthalic anhydride.”

1,3EPE-DPA is the abbreviation for compound with a chemical name of “4,4′-(1,3-phenylenebis(ethyne-2,1-diyl))diphthalic anhydride.”

EPPE-DPA is the abbreviation for compound with chemical names of “4′-((3,4-dicarboxyphenyl)ethynyl)biphenyl-3,4-dicarboxylic dianhydride,” and “4,4′-(biphenyl-4,4′-diylbis(ethyne-2,1-diyl))diphthalic anhydride.”

LC is the abbreviation for liquid-crystalline or liquid-crystallinity.

LDPA is the abbreviation for linked di(phthalic dianhydride) moiety.

MPDA is the abbreviation for multi-phenoxy-linked 4,4′-dianiline.

PE-DPA or PEDPA is the abbreviation for compound with a chemical name of “4′((3,4-dicarboxyphenyl)ethynyl)biphenyl-3,4-dicarboxylic dianhydride.”

PIE is the abbreviation for “phthalimide-ester” moiety.

PMDA is the abbreviation for pyromellitic dianhydride.

PMDI: is the abbreviation for pyromellitimide moiety.

POM is the abbreviation for Polarization Optical Microscopy.

NR-DPA is the abbreviation for Non-Reactive Di-(Phthalic Dianhydride).

R-DPA is the abbreviation for Reactive Di-(Phthalic Dianhydride).

TPDA is the abbreviation for compound with a chemical name of “terphenyl-3,3″,4,4″-dianhydride”.

TLC is the abbreviation for thermal crystalline or thermal crystallinity.

PA is the abbreviation for phthalic anhydride.

PEPA is the abbreviation for 4-phenylethynylphthalic anhydride.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Additive manufacturing or 3-dimensional (3D) printing makes three-dimensional objects by building up material, based upon design data provided from a computer aided design (CAD) system. One technique is to deposit a resolidifiable material in a predetermined pattern, according to design data provided from a CAD system, with the build-up of multiple layers forming the object. The resolidifiable “ink” materials can be either in the form of filaments or powdered resins.

Fused Filament Fabrication (or FFF) is one type of additive manufacturing (AM) technique. Materials used for fused filament fabrication are typically thermoplastic (linear) polymers in the form of filaments. The filaments are melted in a “printer” head and extruded onto a deposition surface, and form a solid layer upon cooling. Multiple layers are deposited one atop the other. The complete ensemble of the layers forms the 3-dimensional article.

Selective Laser Sintering (SLS) is another type of AM technique that uses a laser as the power source to sinter powdered material, aiming the laser focus automatically at points in space defined by a 3D model, binding the material together to create a solid structure. For hot environment applications such as those that can be found in aerospace applications, state of the art 3D printed thermoplastic articles lack key properties that enable use as engine externals or brackets and fixtures in cooler sections of an engine, ducting for cabin air, etc. Currently, the commonly used thermoplastic materials used in FFF or SLS technology are limited in use temperature and have poor thermo-oxidative stability. For example, state-of the-art 3D filament printable aerospace grade thermoplastics such as ULTEM™ 1010, and ULTEM™ 9085 have use temperatures of 190° C. and 160° C., respectively, and are susceptible to creep during the 3D printing process. These thermoplastic melts are isotropic, that is they are not liquid-crystalline.

Accordingly, there is a need for new materials and methods for use in FFF, SLS, and other additive manufacturing techniques that demonstrate improved thermal stability, possess higher service-temperatures and have processibility like thermotropic liquid-crystalline polymers (TLCP). In TLCP systems, because of the generally lower melt viscosity associated with columnal or anisotropic flow as the result of the polymer-chain alignment in the liquid crystalline phase, which would likely to occur in the nozzle of a 3D printer, it is expected that liquid-crystalline character of the ink materials and ability to tailor such character would be advantageous to the above-mentioned additive manufacturing methods.

In thermotropic LC polymers, the transition temperatures from a crystal phase to a liquid crystal phase (LC), which may consist of one or more distinctly different LC textures observed under a polarized optical microscope (OPM), and finally to an isotropic phase, are strongly dependent on the molecular structures of mesogenic component and polymer chain as well as the molecular weight, as evidenced by the work of S. Hocine and M.H. Soft Matter, 2013, vol. 9, pp, 5839-5861. The LC temperature range is generally determined from the onset temperature at which the crystalline phase (ordered and rigid) of LCP begins to transform to liquid-crystalline phase (ordered but mobile) to the temperature at which significant amount of isotropic melt (biphasic) is observed. This former temperature is denoted as “crystal-to-liquid-crystal” or T_{Crys-LC}, and the latter is designated as Tᵢₛₒ

For thermotropic LCP, there are generally two types of LC morphology depending on the structures driven by the dynamics of the molecular-to-meso-scale arrangements of the mesogenic units in the polymer chains. When the morphology of the LC phase shows only an orientational ordering of the mesogenic units in the LCP following a general direction or a director, and no positional ordering, this relatively simple LC phase is designated as “nematic” phase. On the other hand, the morphology of LC phase designated as “smectic” mesophase is more complex. It has a lamellar or layered structure that is characterized by the state of being both orientationally and positionally ordered, in which the mesogens self-organize in parallel layers. In addition, the general orientation of the parallel mesogens in one layer with respect to similarly parallel mesogens in the next layers can be “in-line” (Smectic-A), “offset” (Smectic B) or “offset and tilted” (Smectic C). Therefore, for the smectic morphology, one or more thermal and associated phase transition temperatures may be observed between T_{Crys-CL} and Tᵢₛₒ.

The viscosity of the LC phase is a critical determinant in enhancing the processing ease for thermotropic LCP into fibers or oriented films. The macromolecules of LCPs are very stiff and generally have a rigid-rod structure. These rod-like macromolecules tend to align more easily than the coil-like macromolecules of amorphous thermoplastics along the flow or sheer direction under appropriate processing conditions. In comparison with typically linear thermoplastic polymers, the melt viscosity of LCP is generally lowered when they are molecularly aligned; and in many cases, a small amount of LCP added to thermoplastic polymers can result in a significantly lower melt viscosity in comparison to the pure melt of the thermoplastics, as illustrated by the work of Y. Z. Meng, et al. Polymer 1998, vol. 39, pp. 1845-1850.

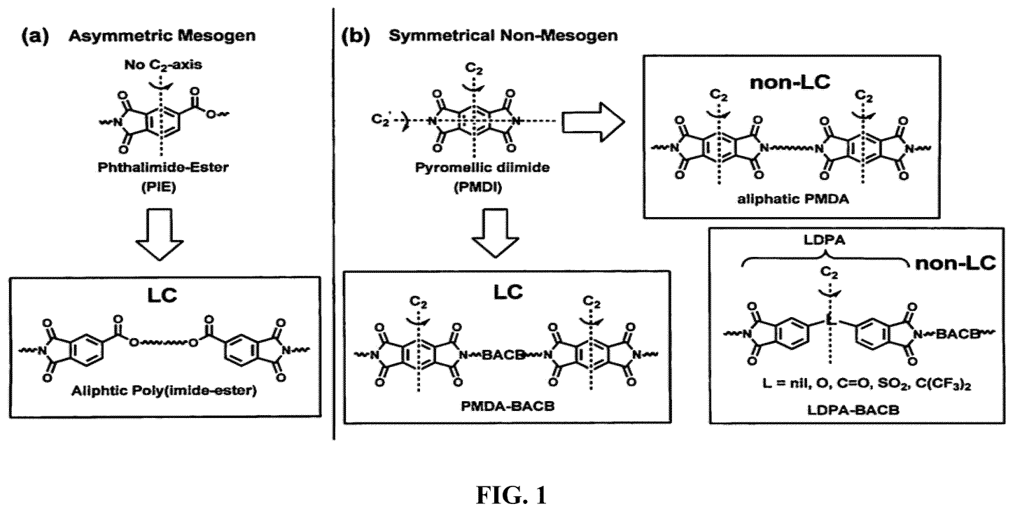

A special class of thermotropic liquid-crystalline polymer (TLCP) is the main-chain polyimides (PI) which are typically synthesized from the polycondensation of an aromatic dianhydride and a diamine. These traditional thermotropic liquid-crystalline polyimides (TLCP-PI) are constituted by (i) the rigid dianhydride being the mesogen capable of self-aggregation to form the so-called liquid-crystalline (LC) phase, i.e., a mesophase which is a phase between crystal and isotropic melt phases; (ii) the diamine being the flexible and thermally mobile to facilitate the self-aggregation of the mesogenic units. From the structural standpoint of mesogenic anhydrides, there are generally two approach to the synthesis of thermotropic liquid-crystalline polyimides (TLC-PI), namely the utilization of mesogens that are either symmetrical dianhydrides such as pyromellitic dianhydride (PMDA), 3,4,3′,4′-biphenyltetracarboxylic dianhydride (BPDA) and TPDA whose symmetry is defined by having a C₂-rotation molecular axis and unsymmetrical di(anhydride-ester) with the generic structure, 3.E-L-AE, in which the AE is an unsymmetrical anhydride, and L is a bivalent linking group (see FIG. 1 for the corresponding imide structures). Other symmetrical dianhydrides are 3,4,3′,4′-benzophenone tetracarboxylic dianhydride (BTDA), 3,4,3′,4′-diphenylsulfone tetracarboxylic dianhydride (BSDA) and 4,4′-oxy-di(phthalic anhydride) (ODPA). There have been a number of systematic studies conducted on the syntheses and TLC correlation of various aromatic-aliphatic semirigid polyimides composed of these symmetrical dianhydrides and aliphatic chains in the main chains. A general finding is that most of them are crystalline; and because of their poor mesogenic properties, they are unable to show TLC properties without the inclusion of a traditional biphenyl mesogen in the polymer backbones; thus poly(ester-imides) and poly(carbonate-imides) that were composed of asymmetric N-phenylphthalimide rings form LC phases. For examples, the work of M. Sato, et al. High Performance Polymers 1998, 10, 155-162, and that of T. Inoue, et al. Macromolecules 1995, vol. 28, pp. 6368-6370, have shown that the-thermotropic liquid crystals for the simple polyimides which consist of symmetrical imide rings and polymethylene spacers appear to be only that derived from TPDA and 1,11-diaminoundecane.

Pyromellitic dianhydride (PMDA) is a common, structurally rigid dianhydride, and the key building block for the well-known aromatic polyimide, namely Kapton, which is a semi-crystalline polymer. As illustrated by the work of H. R. Kricheldorf, et al. Makromolekulare Chemie, 1993, vol. 194, pp 1209-24, and that of M. Sato, et al. Polymer Journal 2002, vol. 34, pp. 158-165, while PMDA meets the structural rigidity of being an LC mesogen, a large number of polyimides and poly(ester-mide)s derived from PMDA and aliphatic components only form isotropic (non-LC) melts. Therefore, it was rather unusual that a thermotropic liquid-crystalline polyimide (TLC-PI) was reported in 1994 by Asanuma et al. Journal of Polymer Science, Part A: Polymer Chemistry 1994, 32, 2111-18. This particular polyimide, designated as PMDA-BACB, was synthesized from PMDA and a highly aromatic but flexible diamine, namely, 1,3-bis[4′-(4″-aminophenoxy)cumyl]benzene (BACB).

However, while PMDA-BACB polyimide is a thermotropic liquid crystalline polymer, its LC phase can be achieved at temperatures well above 300° C. and the associated melt viscosity is deemed impractical for the 3D-printing of thermoplastic or thermosetting polyimides. These processing issues are stemming from the exceeding strong propensity of the PMDA moieties to aggregate. Therefore, there is a need for non-PMDA dianhydrides that can lead to LC phase at or below 300° C. and/or are capable of thermal crosslinking at temperatures after LC transition temperatures.

Non-PMDA mesogenic dianhdrides with higher aspect ratios: A special family of rigid dianhydrides is based on α,ω-diphthalic dianhydride (DPA) motif, designated here as L(DPA), with the generic structure,

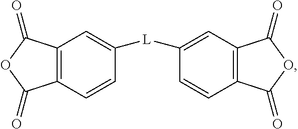

and formula as PA-L-PA, where PA is phthalic anhydride and L is direct bond or an aromatic and/or conjugated connector. The simplest L(DPA) dianhydride, namely, BPDA (3,3′,4,4′-biphenyltetracarboxylic dianhydride; L=direct bond) is not mesogenic even when combined with the very flexible aliphatic, α,ω-(CH₂)ₙ, chains to enable the resulting polyimides to be thermotropic liquid-crystalline (TLC). Further, when the two PA units are connected by the most rigid two-carbon unit, namely the ethynyl bridge, the resulting ethynyl-diphthalic dianhdride) or EDPA in combination with the LC-promoting, highly aromatic diamine BACB, the resulting polyimide, EDPA-BACB is also not mesogenic.

However, when the two PA units are connected by a longer paraphenylene bridge, the resulting “higher-aspect-ratio” dianhydride, namely, TPDA (3,3′,4,4′-p-terphenyltetracarboxdianhydride; L=paraphenylene) and diamines containing similar aliphatic chains did indeed result in TLC-polyimides, as shown by the work of M. Sato, et al. Macromolecular Chemistry and Physics 1996, vol. 197, pp. 2765-2774. Thus, a TLC-PI can be obtained with the TPDA-BACB combination.

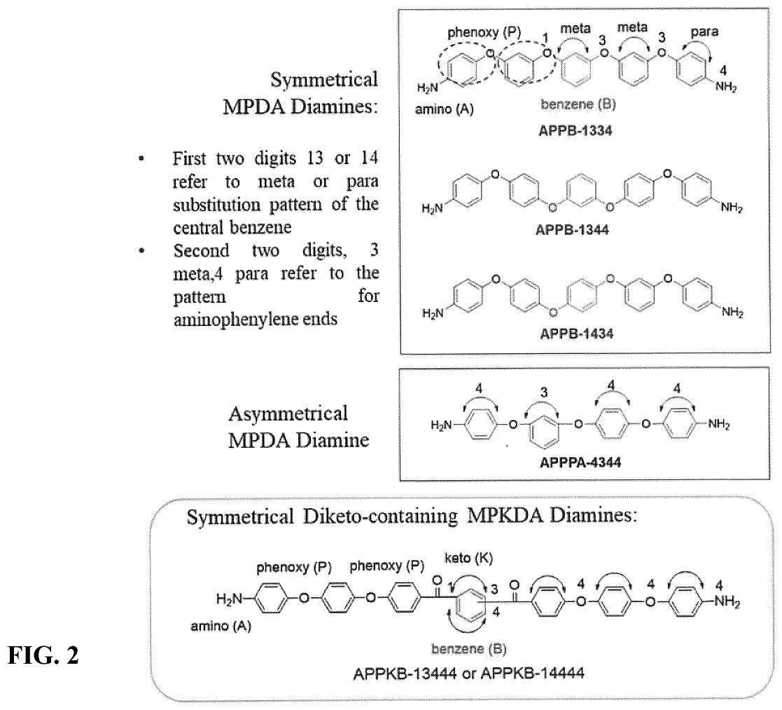

However, because of the aliphatic cumyl (Me₂C<) groups in the structure of BACB, the upper limit for high-temperature tolerance would be limited and replacing them with moieties that does not contain any sp³-carbon, similar or smaller in size, and amenable to thermally induced flexibility. Such moiety can be found in the appropriately linked phenoxy and oxyphenylene (—O—C₆H₄—) structures for all-aromatic diamines that can enable liquid-crystallinity in polyimides when combined with mesogenic dianhydrides. Described here are some of these multiple phenoxy-linked di-aniline (MPDA) monomers and a special MPDA monomer, namely, APPKB-13444 that has a central meta (1,3)-dibenzoylbenzene moiety, in which structure the asymmetric placements of two carbonyl (keto) groups between two separate sets of phenylene rings have apparently suppressed the proclivity of benzophenone moiety in polyimide toward forming crystalline phase and have enhanced promoting the LC-phase instead. The structures and coding of these MPDA diamines are depicted in FIG. 2.

Design and Synthesis of MPDA diamines. As the flexible diamine with the para-oriented 4-aminophenoxy endgroups will provide higher aspect ratio than the meta-oriented 3-aminophenoxy endgroups in the resulting N-phenylphthalimide units to enhance the likelihood of liquid-crystallinity in conjunction with rigidly linked diphthalic dianhydrides (LDPA) to form polyimides, the MPDA diamines all share this common structural and reactivity feature. However, the flexible bis(3-aminophenoxy)1,3-benzene (BAPB), which is a commercially available diamine was used for comparison purposes to validate the requirement of structural motif of (4-aminophenoxy)-L-(4-aminophenyl) to promote liquid crystallinity in the polyimides, MPDA-LPDA.

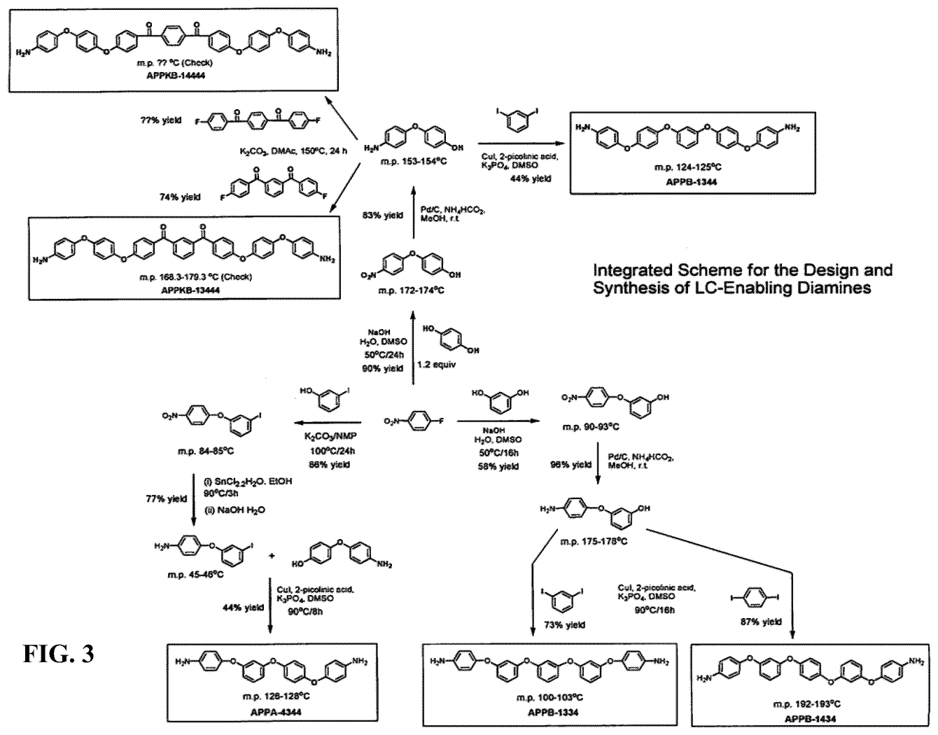

With reference to FIG. 3, our integrated synthesis of MPDA diamines starts with 4-nitrofluobenzene which would lead to 4-hydroxyphenyl-, 4-nitrophenoxy and 4-aminophenoxy-containing arylether. Aromatic nucleophilic substitution reaction was used exclusively in grand scheme. When the displaced halide was not activated and/or in the meta position, iodide as the leaving group and copper catalyst were required for moderate-good yields of the substituted products. For the synthesis of the 1,3-dibenzoylbenzene-containing diamine, APPKB-13444, the requisite aromatic difluoride precursor, 3-di(fluorobenzoyl)benzene is obtained commercially.

Composition and Synthesis of New Crosslinkable Thermotropic Polyimides: Here, we show that certain non-PMDA dianhydrides in combination with certain MPDA can also form thermotropic LC polyimide. In an embodiment, certain rigidly linked bis(phthaalic dianhydrides) or LDPA's with higher aspect ratios than BPDA and BTDA (Table 2) when in combination with MPDA can result in a new family of thermotropic and crosslinkable LC-PI's. In yet another embodiment, when endcapped with thermally crosslinkable functional group such as phenyethynyls, the resulting MPDA-based reactive oligoimides are thermotropic liquid-crystalline that can be cured in isotropic polyimide thermosets.

Molecular Weight Dependency of Thermotropic Liquid Crystallinity (TLC). Unlike small-molecule liquid-crystals which have polydispersity (PD) or molecular weight distribution (MWD) of unity, linear and thermotropic liquid crystalline polymers (TLCP) are characterized by having MWD values dictated by the polymerization conditions. Therefore, the thermal-transition and morphological characteristics of the corresponding liquid-crystalline phase are also dependent on the MWD of TLCP. Similar to the thermal-transition temperatures for amorphous and semi-crystalline polymers, there is generally a linear correlation between molecular weight and the transition temperatures of thermotropic LCP, including those of the mesophase transitions. Therefore, for consistency in studying the effect of changing the dianhydride from PMDA to those of bis(phthalic diahydride) or DPA with various linking group (L) in MPDA-containing and low-molecular weight polyimides (hereafter generically referred to as “imide oligomers” or “oligoimides”), degree of polymerization (DP) or theoretical number of repeating units (n) is set at 12 by controlled synthesis based on Carothers' equation.

Reactive and Non-reactive Mesogenic Dianhydrides (R-DPA & NR-DPA): Our non-PMDA mesogens, i.e., L(DPA),

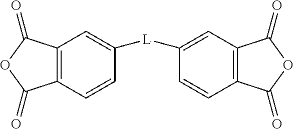

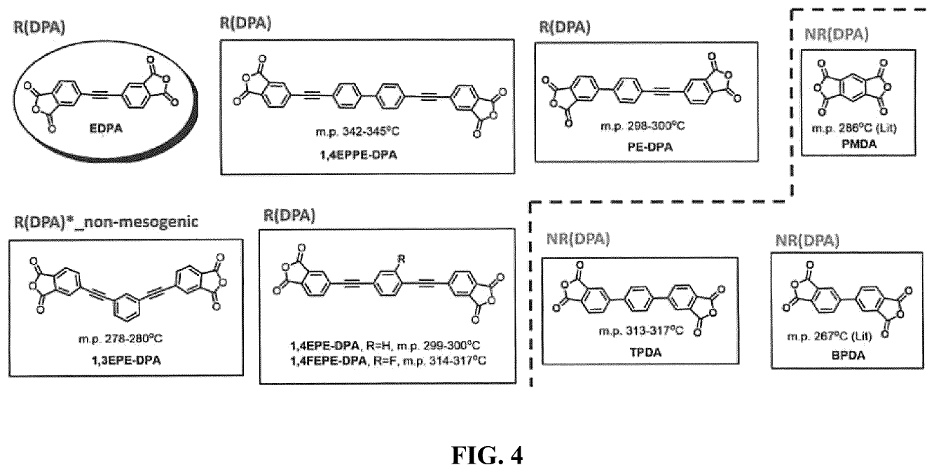

belong to a family of aromatic rod-like dianhydrides with the general composition and formula of (PA)-L-(PA), where PA is phthalic anhydride and L is rigid connector such as an ethynyl (E), a paraphenylene (P), or a rigid moiety of a P-E combination; L can be divided into a reactive (R) group that contains one or more thermally reactive ethynyl (E) units, and non-reactive (NR) group when does not contain any ethynyl (E) unit such as the paraphenylene (P) and fluoro-substituted paraphenylene (PF). The generic structure is similar to that in FIG. 1(b) except that L is a rigid bridging group instead of the flexible group made up by polymethylene or polyoxyethylene chains. Structures of some examples of reactive and nonreactive mesogenic dianhydrides are shown in FIG. 4.

Aromatic Endcappers. The use of thermally reactive 4-ethynylphthalic anhydride (PEPA) and non-reactive phthalic anhydride (PA) as endcapping agents would allow the control of the crosslinking density of L(DPA)-containing TLC-PI products. Thus, when the PE moiety are present in both the backbone and the termini of TLC-PI, higher crosslinking density is expected than when PE is only present in the polymer backbone.

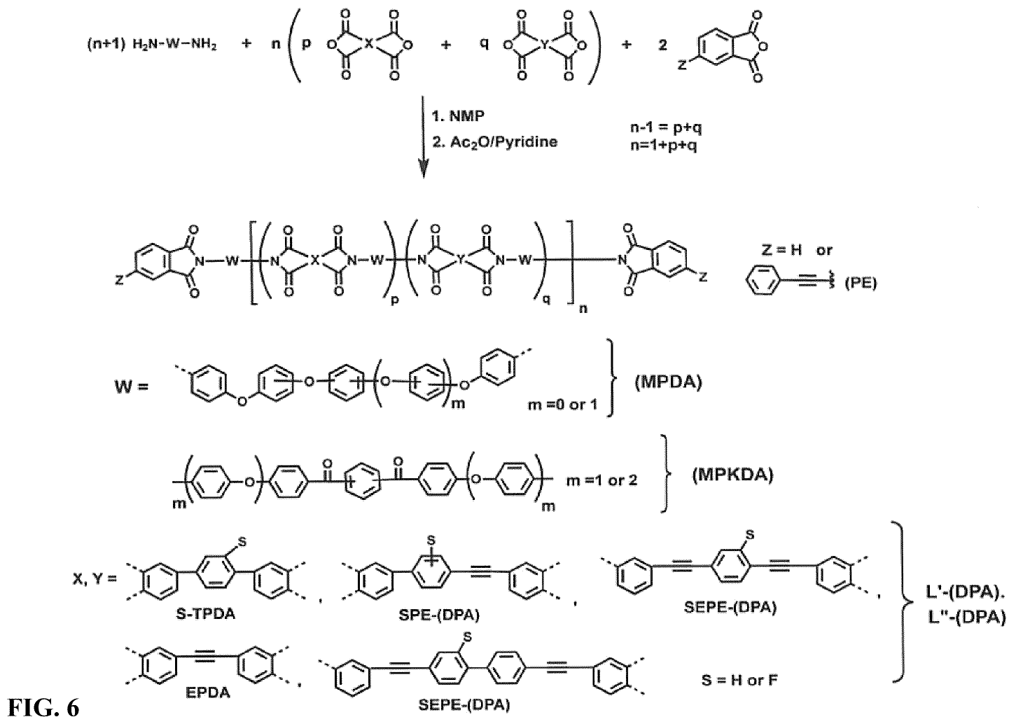

Composition and Preparation of MPDA-based and MPKDA-based LC and Crosslinkable Co-polyimides. Given any ternary combination of (i) a mesogenic non-reactive dianhydride, a mesogenic reactive dianhydride, and MPDA diamine or (ii) a mesogenic non-reactive dianhydride, a mesogenic reactive dianhydride, and MPKDA diamine or (iii) two different mesogenic reactive dianhydrides (R′DPA and R″DPA) and MPDA diamine; (iv) two different mesogenic reactive dianhydrides (RDPA and R′DPA) and MPKDA diamine that can result in liquid crystallinity, and in conjunction with an aromatic endcapper (PA or PEPA), eight series of endcapped thermotropic liquid-crystalline and crosslinkable co-polyimides (TLC-coPI) based on non-reactive mesogenic dianhydride (NRDPA) such as PMDA and TPDA, reactive mesogenic dianhydrides R(DPA) and reactive (PEPA) or nonreactive (PA) endcappers can be designed accordingly with the following generic composition and structures:
(A) Phthalic anhydride or PA-endcapped series:
   (i) PA-[(MPDA-RDPA)ₚ-(MPDA-NRDPA)_{q}]ₙ-PA
   (ii) PA-[(MPKDA-RDPA)ₚ-(MPKDA-NRDPA))_{q}]ₙ-PA
   (iii) PA-[(MPDA-R′DPA)ₚ-(MPDA-R″DPA))_{q}]ₙ-PA
   (iv) PA-[(MPKDA-R′DPA)ₚ-(MPKDA-R″DPA))_{q}]ₙ-PA
(B) 4-ethynylphthalic anhydride, or PEPA-endcapped series:
   (v) PEPA-[(MPDA-RDPA)ₚ-(MPDA-NRDPA))_{q}]ₙ-PEPA
   (vi) PEPA-[(MPKDA-RDPA)ₚ-(MPKDA-NRDPA))_{q}]ₙ-PEPA
   (vii) PEPA-[(MPDA-R′DPA)ₚ-(MPDA-R″DPA) )_{q}]ₙPEPA
   (viii) PEPA-[(MPKDA-R′DPA)ₚ-(MPKDA-R″DPA))_{q}]ₙ-PEPA
      where RDPA, R′DPA and R″DPA are, respectively, any, first and second thermally reactive mesogenic dianhydrides, and NRDPA is a nonreactive mesogenic dianhydride such as PMDA and TPDA; subscripts p and q are molar fractions, and their sum is defined to be 1. The generic synthesis of these series of the liquid-crystalline and crosslinkable coPIs with either phthalimide (PhI) or 4-phenylethynylphthalimide (PEPI) endgroup are outlined in the scheme depicted in FIG. 6.

Proof of Concept/Reduction to Practice: The following 8 examples of binary co-polyimides are provided as the reduction to practice for the claimed composition and preparation of MPDA-based and MPKDA-based LC and crosslinkable co-polyimides. Their chemical compositions are provided as idealized structural representations depicted below and the definition of N, W, X, Y, and Z as well as the value ranges for n, p, and q are provided in the brief description of FIG. 2, respectively.

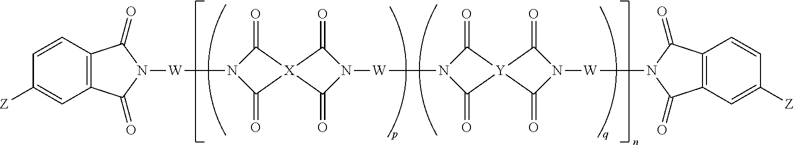

Based on Carathers' equation for the synthesis of the copolymer with the degree of polymerization (n) being 12, the stoichiometric conditions for the polycondensation of two dianhydrides, a common diamine and an endcapping agent are depicted in Table 1. Their thermal and morphological properties are summarized in Tables 2 and 3.

As indicated in Table 1, the composition variability of the binary copolymers are exemplified by using (i) TPDA as a nonreactive, mesogentic dianhydride co-monomer; (ii) PEDPA, E(FP)E-DPA or EPE-DPA as a reactive, mesogenic dianhydride co-monomer; (iii) either APPB-1344 or APKB-1344 as the common diamine monomer; and either phthalic anhydride (PA) or 4-phenylethynylphthalic anhydride (PEPA) as the nonreactive or reactive endcapping agent, respectively. Because only a common diamine monomer is used in these binary copolymer compositions, the molar ratio of the two types of repeating units is thus determined by the molar ratio of the two dianhydrides used, namely Dianhydride-1:Diahydridride-2; only the ratios of Dianhydride-1:Diahydridride-2 being 9:1 and 8:2 were used in these examples.

TABLE 1
The stoichiometry of the dianhydrides 1 and 2, diamine and endcappers
for the preparations of the endcapped thermotropic liquid-crystalline
co-polyimides that are thermally crosslinkable.

| | Dianhydride 1 | Dianhydride 2 | Diamine | PA | PEPA |
|---|---|---|---|---|---|
| Sample ID | (mmol) | (mmol) | (mmol) | (mmol) | (mmol) |
| 08-76-1* | TPDA (9.6) | PEDPA (2.4) | APPB-1344 (13.0) | 2.0 | 0 |
| 08-76-2* | TPDA (9,6) | PEDPA (2.4) | APPB-1344 (13.0) | 0 | 2.0 |
| 08-77-1** | TPDA (10.8) | PEDPA (1.2) | APPB-1344 (13.0) | 2.0 | 0 |
| 08-77-2** | TPDA (10.8) | PEDPA (1.2) | APKB-1344 (13.0) | 0 | 2.0 |
| 08-79-1** | E(FP)E-DPA (10.8) | EPE-DPA (1.2) | APKB-1344 (13.0) | 2.0 | 0 |
| 08-79-2** | E(FP)E-DPA (10.8) | EPE-DPA (1.2) | APKB-1344 (13.0) | 0 | 2 |
| 08-80-1** | E(FP)E-DPA (10.8) | EPE-DPA (1.2) | APPB-1344 (13.0) | 2.0 | 0 |
| 08-80-2** | E(FP)E-DPA (10.8) | EPE-DPA (1.2) | APPB-1344 (13.0) | 0 | 2 |

Footnote to Table 1:
*Dianhydride 1:Dianhydride 2 = 8:2.
**Dianhydride 1:Dianhydride 2 = 9:1

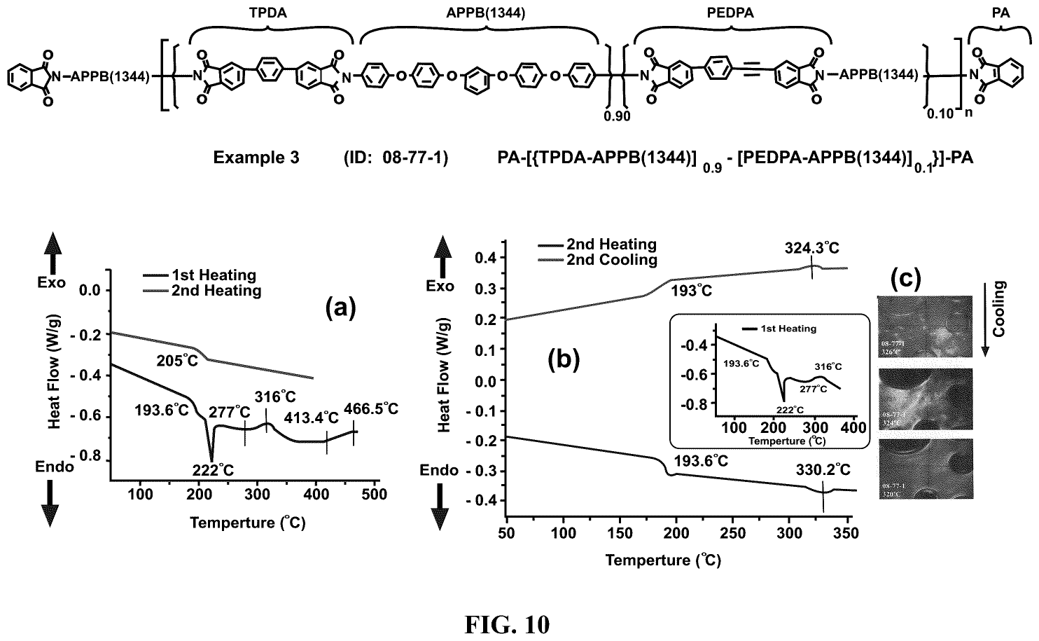

Table 2 summarizes the results of thermal characterization and morphological assessment of the 8 representative examples for the crosslinkable, thermotropic liquid-crystalline co-polyimides. The results indicate that all of them are glass-like and liquid-crystalline as revealed by either both differential scanning calorimetry (DSC) scans (i.e., heating scan between room temperature and 360° C. to detect T_{g}, Tₘ and T_{LC-iso} (liquid crystal or LC-to-isotropic melt transition temperature) and cooling scan between 360° C. and room temperature to detect T_{crys} (crystallization temperature) and T_{iso-LC} (isotropic melt-to-LC transition) and hot-stage polarization optical microscopy (POM) or just POM assessment. Their glass-transition temperatures range from 163° C. to 232° C., likely stemming from the aromatic APPB-1344 and APBK-1344 segments. The combination of nonreactive TPDA and reactive PEDPA dianhydride mesogens allow DSC .detection of the liquid-crystalline phase with well-defined T_{LC-iso} ranging from 309.6-339.9° C., and T_{iso-LC} ranging from 304.8-330.8 ° C., in the DSC heating and cooling scans of the co-polymers. However, the combinations of two mesogenic dianhydrides such as EPE-DPA and F(FP)E-DPA that both have persistence (molecular) lengths higher than that of either TPDA or PEDPA have resulted in more well-defined melting at higher temperatures, i.e., their Tₘ ranging from 314.7-331.5° C. and about 83-100° C. higher as compared with the Tₘ 222° C. for the TPDA-PEDPA-containing co-polyimide 08-77-1, for example. While thermal analysis alone is probably not sensitive to detect the liquid-crystalline phase of these copolyimides, the hot-stage polarization optical microscopy has aided in revealing the existence of their LC phases somewhere between 340-360° C. by cooling their near-isotropic melts at 360° C. (see FIGS. 10-13).

TABLE 2
Thermal properties of the co-polyimides determined by DSC after
scan and rescan between 0° C. and 360° C., and the observed liquid-crystalline
and crystal phases by hot-stage polarization microscopy.

| | T_{g} | Tₘ | T_{LC-iso} | T_{iso-LC} | T_{crys} | |
|---|---|---|---|---|---|---|
| Sample ID | (° C.)^{a} | (° C.)^{a} | (° C.)^{a} | (° C.)^{a} | (° C.)^{a} | Phase^{b} |
| 08-76-1 | 164.5 | ND | 309.6 | 304.8 | ND | Liquid Crystalline phase |
| 08-76-2 | 164.2 | ND | 321.3 | 311.8 | ND | Liquid Crystalline phase |
| 08-77-1 | 193.6 | 222.0 | 330.2 | 324.3 | ND | Crystalline & Liquid Crystalline phase |
| 08-77-2 | 191.6 | ND | 339.9 | 330.8 | ND | Liquid Crystalline phase |
| 08-79-1 | 224.1 | 330.1 | ND | ND | ND | Crystalline & Liquid Crystalline phase |
| 08-79-2 | 232.3 | 331.5 | ND | ND | ND | Crystalline & Liquid Crystalline phase |
| 08-80-1 | 165.6 | 318.1 | ND | N? | ND | Crystalline & Liquid Crystalline phase |
| 08-80-2 | 162.9 | 314.7 | ND | ND | ND | Crystalline & Liquid Crystalline phase |

^{a}Determined by DSC after scan and rescan from 0° C. to 360° C. with scan rate of 10° C./min (N₂).
^{b}Determined by polarization optical microscopy equipped with variable-temperature hot stage

As all eight examples are capable of being thermally self-reactive, DSC experiments were conducted to assess their reactivities and reaction modes. Typically, the sample was first scan from room temperature to 480° C. under nitrogen atmosphere to reveal the initial glass transition (T_{g,ini}) and melting (Tₘ), which are endothermic and any thermally-induced reaction that is exothermic and normally has an onset temperature (Tₒₙₛₑₜ) and a peak temperature (Tₚₑₐₖ). A second scan from room temperature to 400° C. was run to detect the presence of the so-called cured glass transition temperature (T_{g,cured}) The DSC results for these representative examples are summarized in Table 3

TABLE 3
Thermal properties of the representative examples of crosslinkable,
thermotropic liquid-crystalline co-polyimides as determined by differential
calorimetric analysis (DSC) under nitrogen atmosphere.

| | Initial | 1^{st} Exotherm | 1^{st} Exotherm | 2^{nd} Exotherm | 2^{nd} Exotherm | Cured |
|---|---|---|---|---|---|---|
| Sample ID | T_{g} (° C.)^{a} | Tₒₙₛₑₜ (° C.)^{a} | Tₚₑₐₖ (° C.)^{a} | Tₒₙₛₑₜ (° C.)ª | Tₚₑₐₖ (° C.)^{a} | T_{g} (° C.)^{b} |
| 08-76-1 | 164.5 | 287.7 | 317.1 | 419.1 | 466.5 | 185.3 |
| 08-76-2 | 164.2 | 283.0 | 319.4 | 399.9 | 448.8 | 220.6 |
| 08-77-1 | 193.6 | 290.1 | 316.7 | 413.4 | 466.5 | 205.0 |
| 08-77-2 | 191.6 | 285.3 | 314.8 | 381.0 | 454.1 | 241.6 |
| 08-79-1 | 224.1 | 265.2 | 274.9 | 356.2 | 418.0 | >400° C. |
| 08-79-2 | 232.3 | 252.3 | 276.7 | 357.7 | 417.5 | >400° C. |
| 08-80-1 | 165.6 | 250.1 | 258.4 | 349.4 | 409.9 | >400° C. |
| 08-80-2 | 162.9 | 244.1 | 254.9 | 348.3 | 407.6 | >400° C. |

Footnotes:
^{a}From the first DSC scan (r. t. to 480° C.@ 20° C./min);
^{b}From the second DSC scan (r. t. to 400° C.@ 20° C./min)

With reference to Table 3, the thermal crosslinkability of all the 8 examples have been verified by the presence of two exotherms and the advancement of glass-transition temperature. For the first exotherm, Tₒₙₛₑₜ ranges from 244.1° C. to 290.1° C. and Tₚₑₐₖ ranges from 254.9° C. to 319.4° C. For the second exotherm, Tₒₙₛₑₜ ranges from 244.1° C. to 290.1° C. and Tₚₑₐₖ ranges from 348.3° C. to 419.1° C. The initial T_{g} ranges from 162.9° C. to 232.3° C. and the cured T_{g}, ranges from 185.3° C. to >400° C., resulting in the T_{g} advancement of 11° C. to >237° C. It is interesting to note that while the occurrence of the second exotherm is somewhat shifted to lower temperature zone for the crosslinking reaction by the backbone phenylethynyl group (for example, Tₒₙₛₑₜ and Tₚₑₐₖ for EDPA-based LC-PIs are ˜320-350° C. and ˜400-420° C., respectively), the nature and mechanism of the first exotherm are not clear other than the possibility of being intramolecular covalent rearrangement and aromatization of the conjugated -phenyl-ethynyl-phenyl- segment.

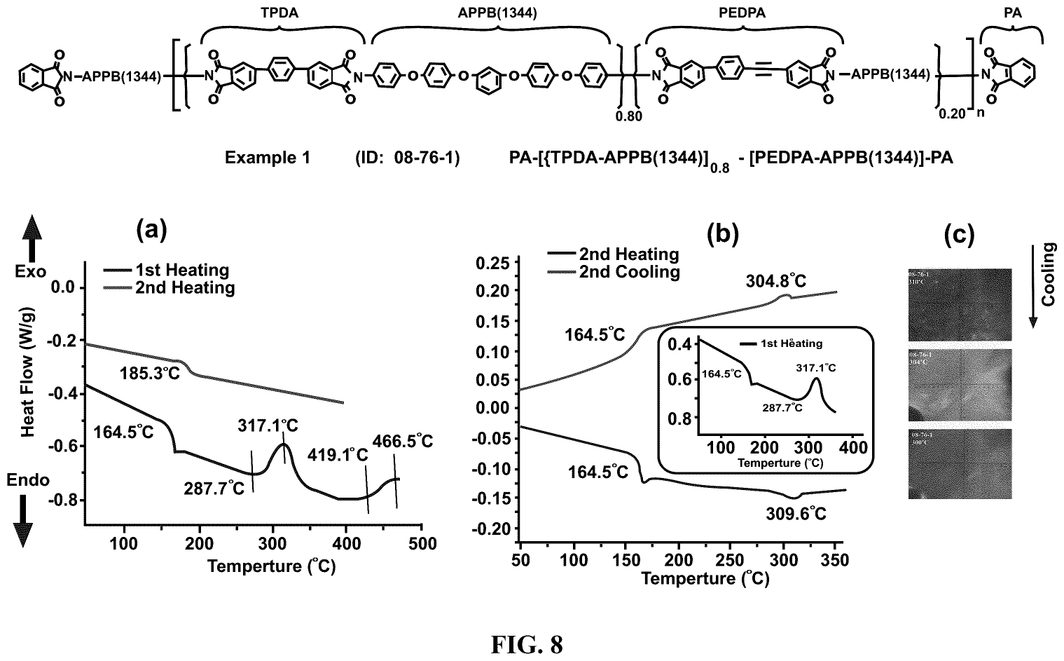

With reference to FIG. 8, the thermotropic liquid crystallinity and thermally induced crosslinkability of co-polyimide 08-76-1, designated as PA-[{TPDA-APPB(1344)]_{0.8}-[PEDPA-APPB(1344)]_{0.2}}]-PA were characterized by differential scanning calorimetry (DSC) and hot-stage polarization optical microscopy (POM). FIG. 8(a) depicts the first heating DSC traces of copolyimide 08-76-1 from room temperature to 475° C. to reveal the initial glass transition (T_{g,ini}) at 164.5° C. and crosslinking-related exotherms. There were two exotherms detected with onset temperatures at 287.7° C. and 419.1° C.; and peak temperature at 317.1° C. and 466.5° C., respectively. The second heating of the sample in the region of r.t. to 400° C. indicated that the glass transition (T_{g,cured}) of the crosslinked product is >400° C. as there was no thermal transition detected below 400° C. FIG. 8(b) depicts the DSC heating and cooling traces in the 0-350° C. region to show glass transition and liquid crystalline phase to isotropic melt transition of this PA-endcapped crosslinkable LC-coPI. It is noteworthy that the T_{g} value remains relatively intact even after the occurrence of thermal reaction associated with the first exotherm that had completely disappeared. This observation suggests that the associated thermal reaction of PEDPA units has little effect on the segmental mobility of the polymer backbone. The T_{g} advancement is apparently controlled by the 2^{nd} exotherm, which is likely stemming from the further crosslinking reaction of the reactive intermediate formed as manifested by the first exotherm. FIG. 8(c) depicts the photos taken at 360° C., 350° C. and 340° C. from viewing the texture changes during the cooling of the 08-76-1 isotropic melt and its transition to a liquid-crystalline phase under a hot-staged polarization optical microscope (POM). The POM observation seems to implicate that the formation thermally stable intermediate has not destroyed the liquid-crystallinity of the copolyimide 08-76-01.

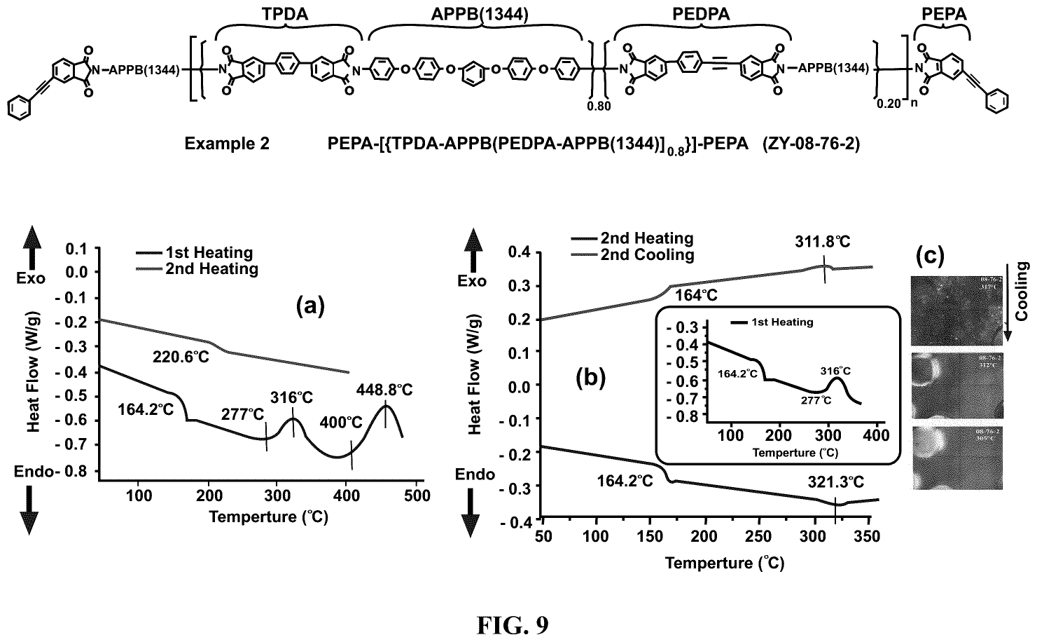

With reference to FIG. 9, the thermotropic liquid crystallinity and thermally induced crosslinkability of co-polyimide 08-76-2, designated as PA-[{TPDA-APPB(1344)]_{0.8}-[PEDPA-APPB(1344)]_{0.2}}]-PA were characterized by differential scanning calorimetry (DSC) and hot-stage polarization optical microscopy (POM). FIG. 9(a) depicts the first heating DSC traces of copolyimide 08-76-2 from room temperature to 475° C. to reveal the initial glass transition (T_{g,ini}) at 164.2° C. and crosslinking-related exotherms. There were two exotherms detected with onset temperatures at 283° C. and 399.9° C.; and peak temperature at 319.4° C. and 448.8° C., respectively. The second heating of the sample from r.t. to 400° C. indicated that the glass transition (T_{g,cured}) of the crosslinked product is >400° C. as there was no thermal transition detected below 400° C. FIG. 9(b) depicts the DSC heating and cooling traces in the 0-350° C. region to show glass transition and liquid crystalline phase to isotropic melt transition of this PEPA-endcapped crosslinkable LC-coPI. It is noteworthy that the T_{g} value remains relatively intact even after the occurrence of thermal reaction associated with the first exotherm that had completely disappeared. This observation suggests that the associated thermal reaction of PEDPA units has little effect on the segmental mobility of the polymer backbone. The T_{g} advancement is apparently controlled by the 2^{nd} exotherm associated with complex high-temperature reactions, which are likely stemming from (a) the reactive but thermally stable intermediate formed under the influence of the first exotherm, (b) thermal crosslinking of the PEPA endgroups, and both (a) and (b). FIG. 8(c) depicts the photos taken at 360° C., 350° C. and 340° C. from viewing the texture changes during the cooling of the 08-76-2 isotropic melt and its transition to a liquid-crystalline phase under a hot-staged polarization optical microscope (POM). The POM observation seems to implicate that the formation thermally stable intermediate has not destroyed the liquid-crystallinity of the copolyimide 08-76-2.

With reference to FIG. 10, the thermotropic liquid crystallinity and thermally induced crosslinkability of co-polyimide 08-77-1, designated as PA-[{TPDA-APPB(1344)]_{0.9}-[PEDPA-APPB(1344)]_{0.1}}]-PA were characterized by differential scanning calorimetry (DSC) and hot-stage polarization optical microscopy (POM). FIG. 10(a) depicts the first heating DSC traces of copolyimide 08-77-1 from room temperature to 475° C. to reveal the initial glass transition (T_{g,ini}) at 193.6° C. and crosslinking-related exotherms. There were two exotherms detected with onset temperatures at 290.1° C. and 413.4° C.; and peak temperature at 316.7° C. and 466.5° C., respectively. The second heating of the sample from r.t. to 400° C. indicated that the glass transition (T_{g,cured}) of the crosslinked product is >400° C. as there was no thermal transition detected below 400° C. FIG. 10(b) depicts the DSC heating and cooling traces in the 0-350° C. region to show glass transition and liquid crystalline phase to isotropic melt transition of this PA-endcapped crosslinkable LC-coPI. It is noteworthy that the T_{g} value remains relatively intact even after the occurrence of thermal reaction of associated with the first exotherm that had completely disappeared. This observation suggests that the associated thermal reaction PEDPA units has little effect on the segmental mobility of the polymer backbone. The T_{g} advancement is apparently controlled by the 2^{nd} exotherm, which is likely stemming from further crosslinking reaction of reactive intermediate formed as manifested by the first exotherm. FIG. 10(c) depicts the photos taken at 360° C., 350° C. and 340° C. from viewing the texture changes during the cooling of the 08-77-1 isotropic melt and its transition to a liquid-crystalline phase under a hot-staged polarization optical microscope (POM). The POM observation seems to implicate that the formation thermally stable intermediate has not destroyed the liquid-crystallinity of the copolyimide 08-77-1.

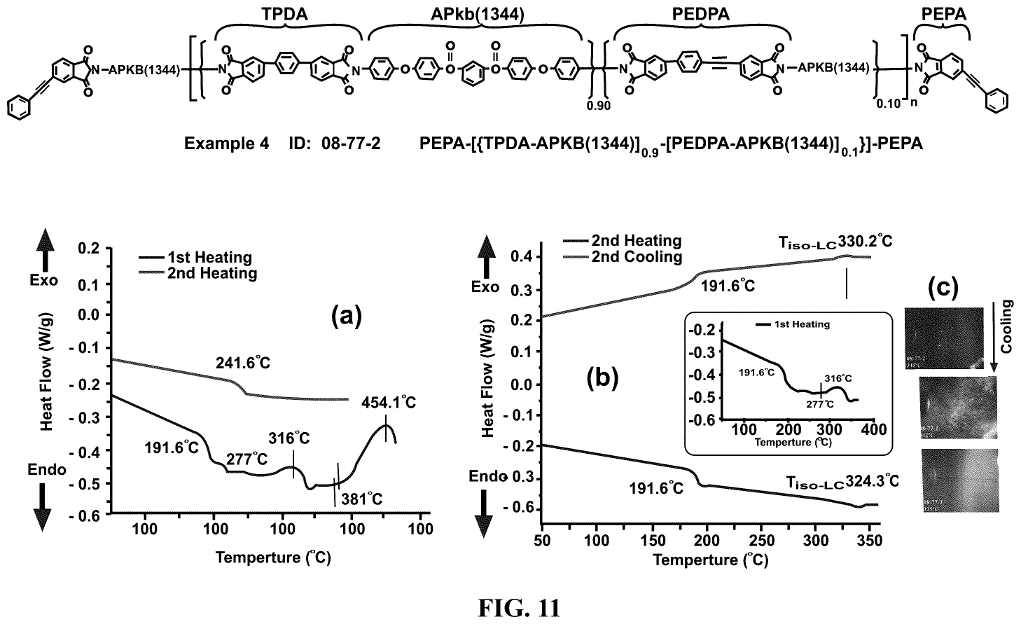

With reference to FIG. 11, the thermotropic liquid crystallinity and thermally induced crosslinkability of co-polyimide 08-77-2, designated as PEPA-[{TPDA-APPB(1344)]_{0.9}-[PEDPA-APPB(1344)]_{0.1}}]-PEPA were characterized by differential scanning calorimetry (DSC) and hot-stage polarization optical microscopy (POM). FIG. 11(a) depicts the first heating DSC traces of copolyimide 08-77-2 from room temperature to 475° C. to reveal the initial glass transition (T_{g,ini}) at 191.6° C. and crosslinking-related exotherms. There were two exotherms detected with onset temperatures at 285.3° C. and 381° C.; and peak temperature at 314.8° C. and 454.1° C., respectively. The second heating of the sample from r.t. to 400° C. indicated that the glass transition (T_{g,cured}) of the crosslinked product is >400° C. as there was no thermal transition detected below 400° C. FIG. 11(b) depicts the DSC heating and cooling traces in the 0-350° C. region to show glass transition and liquid crystalline phase to isotropic melt transition of this PEPA-endcapped crosslinkable LC-coPI. It is noteworthy that the T_{g} value remains relatively intact even after the occurrence of thermal reaction associated with the first exotherm that had completely disappeared. This observation suggests that the associated thermal reaction of PEDPA units has little effect on the segmental mobility of the polymer backbone. The T_{g} advancement is apparently controlled by the 2^{nd} exotherm associated with complex high-temperature reactions, which are likely stemming from (a) the reactive but thermally stable intermediate formed under the influence of the first exotherm, (b) thermal crosslinking of the PEPA endgroups, and both (a) and (b). FIG. 11(c) depicts the micrographs taken at 360° C., 350° C. and 340° C. from viewing the texture changes during the cooling of the 08-77-2 isotropic melt and its transition to a liquid-crystalline phase under a hot-staged polarization optical microscope (POM). The POM observation seems to implicate that the formation thermally stable intermediate has not destroyed the liquid-crystallinity of the copolyimide 08-77-2.

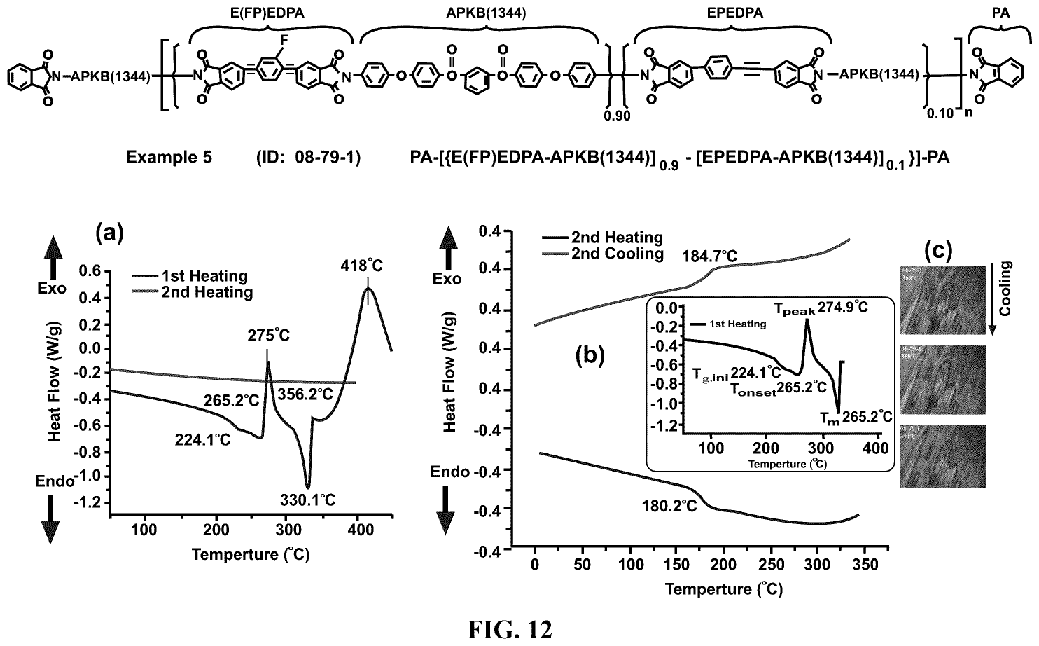

With reference to FIG. 12, the thermotropic liquid crystallinity and thermally induced crosslinkability of co-polyimide 08-79-1, designated as PA-[{E(FP)EDPA-APKB(1344)]_{0.9}-[EPEDPA-APKB(1344)]_{0.1}}]-PA were characterized by differential scanning calorimetry (DSC) and hot-stage polarization optical microscopy (POM). FIG. 12(a) depicts the first heating DSC trace of copolyimide 08-79-1 from room temperature to 475° C. that revealed the initial glass transition (T_{g,ini}) at 224.1° C. and crosslinking-related exotherms. There were two exotherms detected with onset temperatures at 265.2° C. and 365.2° C.; and peak temperature at 274.9° C. and 418° C., respectively. The second heating of the sample from 0° C. to 400° C. indicated that the glass transition (T_{g,cured}) of the crosslinked product is >400° C. as there was no thermal transition detected below 400° C. FIG. 12(b) depicts the DSC heating and cooling traces in the 0-350° C. region that showed glass transition and liquid crystalline phase to isotropic melt transition of this PA-endcapped crosslinkable LC-coPI. It is noteworthy that the T_{g} value remains intact even after the occurrence of thermal reaction associated with the first exotherm that had completely disappeared. It is noteworthy that the intermediate T_{g} value (180.2° C.) has decreased from the T_{g,ini} value by nearly 44° C. after the disappearance of the first exotherm. This observation suggests that the associated thermal reaction of E(FP)EDPA and EPEDPA moieties in the polymer backbone have significant effect on the rigidity of the polymer backbone. The final T_{g} advancement is apparently controlled by the 2^{nd} exotherm, which is likely stemming from the reactive but some yet-to-discerned, thermally stable intermediate formed (associated the first exotherm). FIG. 12(c) depicts the micrographs taken at 360° C., 350° C. and 340° C. from viewing the texture changes during the cooling of the 08-79-1 isotropic melt and its transition to a liquid-crystalline phase under a hot-staged polarization optical microscope (POM). The POM observation seems to implicate that the formation thermally stable intermediate has not destroyed the liquid-crystallinity of the copolyimide 08-79-01.

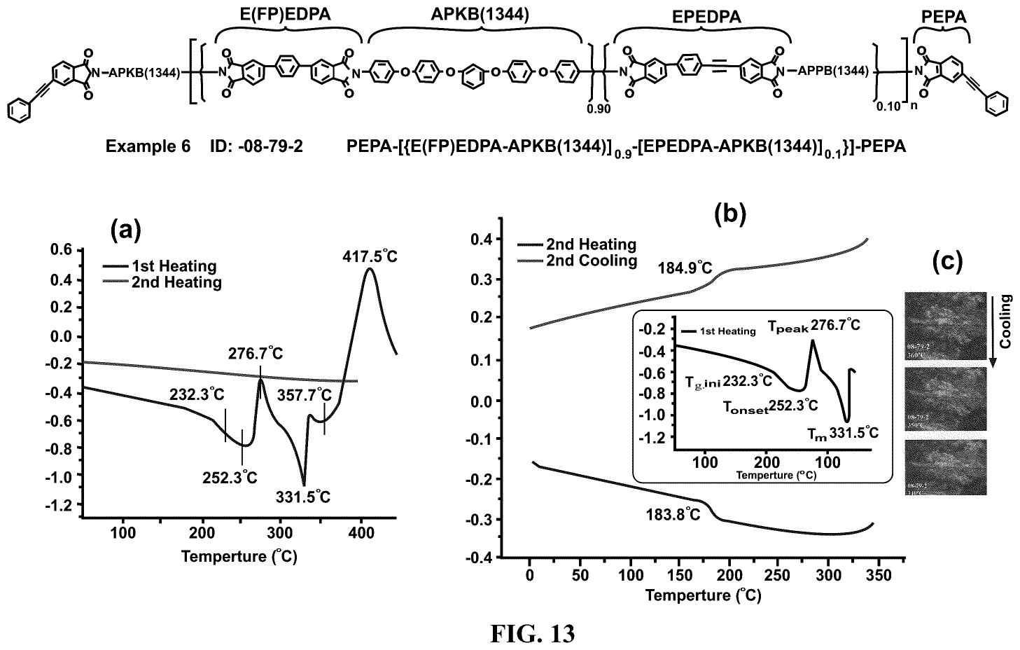

With reference to FIG. 13, the thermotropic liquidcrystallinity and thermally induced crosslinkability of co-polyimide 08-79-2, designated as PEPA-[{E(FP)EDPA-APKB(1344)]_{0.9}-[EPEDPA-APKB(1344)]_{0.1}}]-PEPA were characterized by differential scanning calorimetry (DSC) and hot-stage polarization optical microscopy (POM). FIG. 13(a) depicts the first heating DSC curve of copolyimide 08-79-2 from room temperature to 475° C. to reveal the initial glass transition (T_{g,ini}) at 232.3° C. and crosslinking-related exotherms. There were two exotherms detected with onset temperatures at 252.3° C. and 357.7° C.; and peak temperature at 276.7° C. and 417.5° C., respectively. The second heating of the sample from r.t. to 400° C. indicated that the glass transition (T_{g,cured}) of the crosslinked product is >400° C. as there was no thermal transition detected below 400° C. FIG. 13(b) depicts the DSC heating and cooling traces in the 0-350° C. region to show glass transition and liquid crystalline phase to isotropic melt transition of this PEPA-endcapped crosslinkable LC-coPI. It is noteworthy that the intermediate T_{g} value (183.8° C.) has decreased from T_{g,ini} value by ˜48° C. after the disappearance of the first exotherm. This observation suggests that the associated thermal reaction of E(FP)EDPA and EPEDPA moieties in the polymer backbone have significant effect on the rigidity of the polymer backbone. The final T_{g} advancement is apparently controlled by the 2^{nd} exotherm, which are likely stemming from (a) the reactive but thermally stable intermediate formed under the influence of the first exotherm, (b) thermal crosslinking of the PEPA endgroups, and both (a) and (b). FIG. 13(c) depicts the photos taken at 360° C., 350° C. and 340° C. from viewing the texture changes during the cooling of the isotropic melt of 08-79-2 and its transition to a liquid-crystalline phase under a hot-staged polarization optical microscope (POM). The POM observation seems to implicate that the formation of such thermally stable intermediate has not destroyed the liquid-crystallinity of the copolyimide 08-79-02.

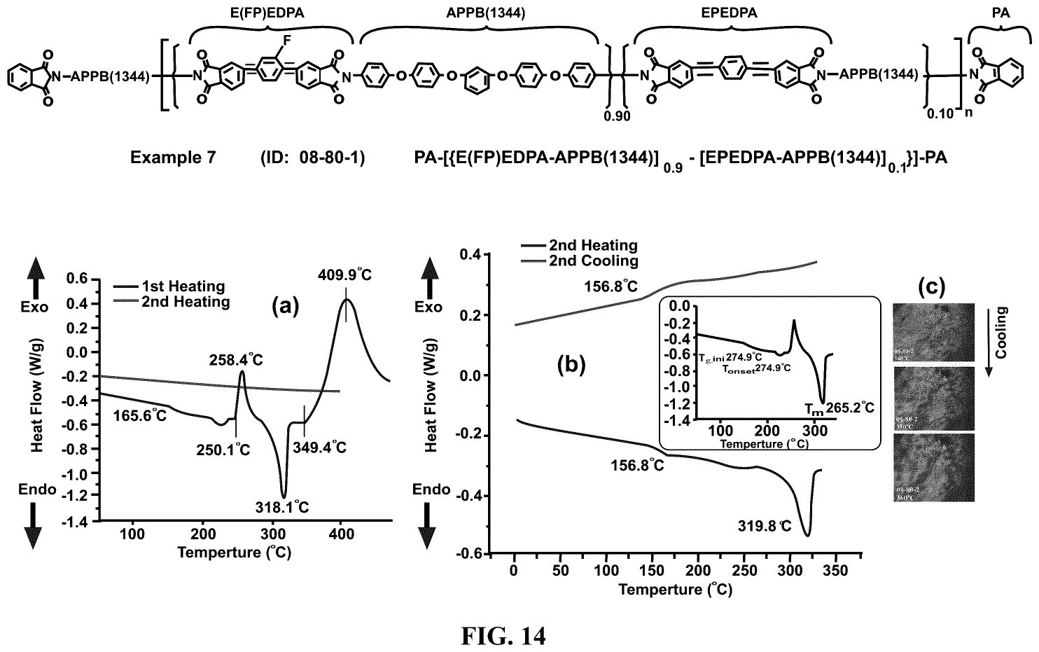

With reference to FIG. 14, the thermotropic liquid crystallinity and thermally induced crosslinkability of co-polyimide 08-80-1, designated as PA-[{E(FP)EDPA-APPB(1344)]_{0.9}-[EPEDPA-APPB(1344)]_{0.1}}]-PA were characterized by differential scanning calorimetry (DSC) and hot-stage polarization optical microscopy (POM). FIG. 14(a) depicts the first heating DSC curve of copolyimide 08-80-1 from room temperature to 475° C. to reveal the initial glass transition (T_{g,ini}) at 165.6° C. and crosslinking-related exotherms, and an initial melting endotherm (Tₘ 318.1° C.). There were two exotherms detected with onset temperatures at 250.1° C. and 349.4° C.; and peak temperature at 258.4° C. and 409.9° C., respectively. The second heating of the sample from r.t. to 400° C. indicated that the glass transition (T_{g,cured}) of the crosslinked product is >400° C. as there was no thermal transition detected below 400° C. FIG. 14(b) depicts the DSC heating and cooling traces in the 0-350° C. region to show glass transition and liquid crystalline phase to isotropic melt transition of this PA-endcapped crosslinkable LC-coPI. It is noteworthy that the intermediate T_{g} value has decreased from T_{g,ini} value by 8.8° C. and the intermediate Tₘ has increased from T_{m,ini} by 1.7° C. after the disappearance of the first exotherm. This observation suggests that the associated thermal reaction of E(FP)EDPA and EPEDPA moieties in the polymer backbone have significant effect on the rigidity and segmental mobility of the polymer backbone. The final T_{g} advancement is apparently controlled by the 2^{nd} exotherm, which is likely stemming from the reactive but thermally stable intermediate formed associated with the first exotherm. FIG. 14(c) depicts the micrographs taken at 360° C., 350° C. and 340° C. from viewing the texture changes during the cooling of the isotropic melt of 08-80-1 and its transition to a liquid-crystalline phase under a hot-staged polarization optical microscope (POM). The POM observation seems to implicate that the formation thermally stable intermediate has not destroyed the liquid-crystallinity of the copolyimide 08-80.1.

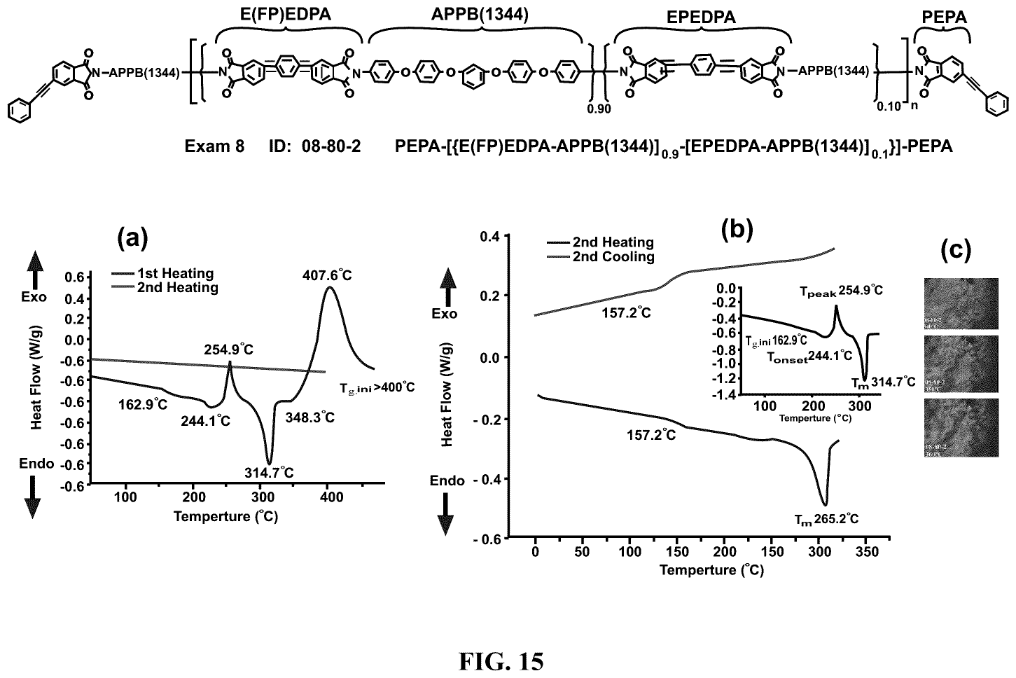

With reference to FIG. 15, the thermotropic liquidcrystallinity and thermally induced crosslinkability of co-polyimide 08-80-2, designated as PEPA-[{E(FP)EDPA-APPB(1344)]0.9-[EPEDPA-APPB(1344)]0.1}]-PEPA were characterized by differential scanning calorimetry (DSC) and hot-stage polarization optical microscopy (POM). FIG. 15(a) depicts the first heating DSC curve of copolyimide 08-80-2 from room temperature to 475° C. to reveal the initial glass transition (T_{g,ini}) at 162.9° C. crosslinking-related exotherms and an initial melting endotherm (Tₘ 314.7° C.). There were two exotherms detected with onset temperatures at 244.1° C. and 348.3° C.; and peak temperature at 254.9° C. and 407.6° C., respectively. The second heating of the sample from r.t. to 400° C. indicated that the glass transition (T_{g,cured}) of the crosslinked product is >400° C. as there was no thermal transition detected below 400° C. FIG. 15(b) depicts the DSC heating and cooling curves in the 0-350° C. region to show glass transition and liquid crystalline phase to isotropic melt transition of this PEPA-endcapped crosslinkable LC-coPI. It is noteworthy that the intermediate T_{g} value (157.2) has decreased from T_{g,ini} value by 5.7° C. and intermediate Tₘ value has increased from T_{m,ini} by 4.3° C. after the disappearance of the first exotherm. This observation suggests that the associated thermal reaction of E(FP)EDPA and EPEDPA moieties in the polymer backbone have a significant effect on the rigidity and segmental mobility of the polymer backbone. The final T_{g} advancement is apparently controlled by the 2^{nd} exotherm, which are likely stemming from (a) the reactive but thermally stable intermediate formed under the influence of the first exotherm, (b) thermal crosslinking of the PEPA endgroups, and both (a) and (b). FIG. 15(c) depicts the photos taken at 360° C., 350° C. and 340° C. from viewing the texture changes during the cooling of the 08-80-2 isotropic melt and its quick transition to a liquid-crystalline phase under a hot-staged polarization optical microscope (POM). The POM observation seems to implicate that the formation thermally stable intermediate has not destroyed the liquid-crystallinity of the copolyimide 08-80-2.

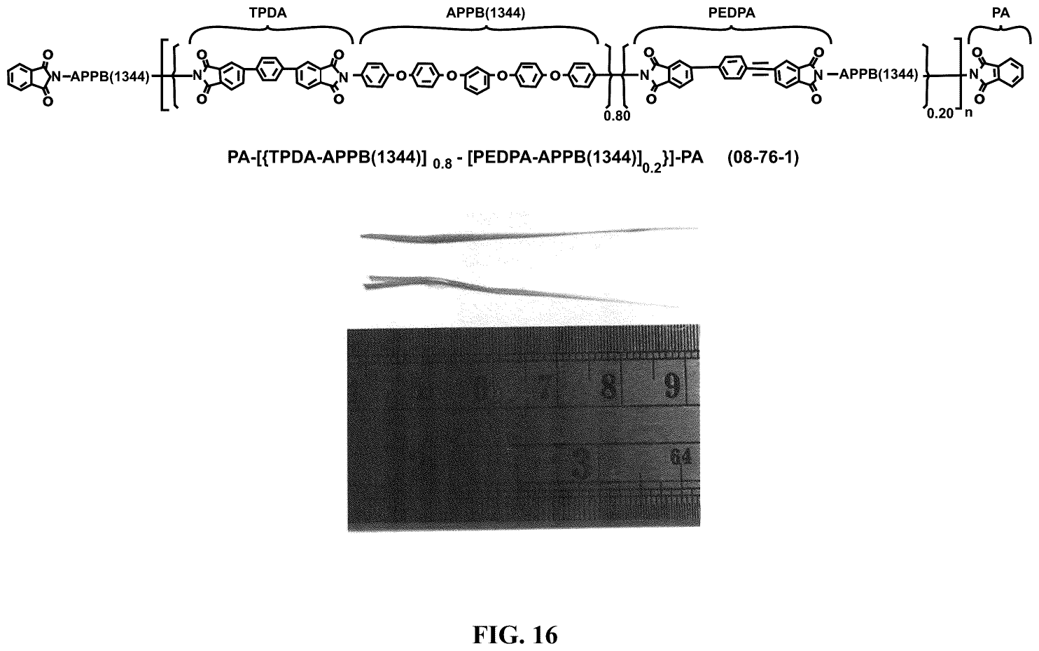

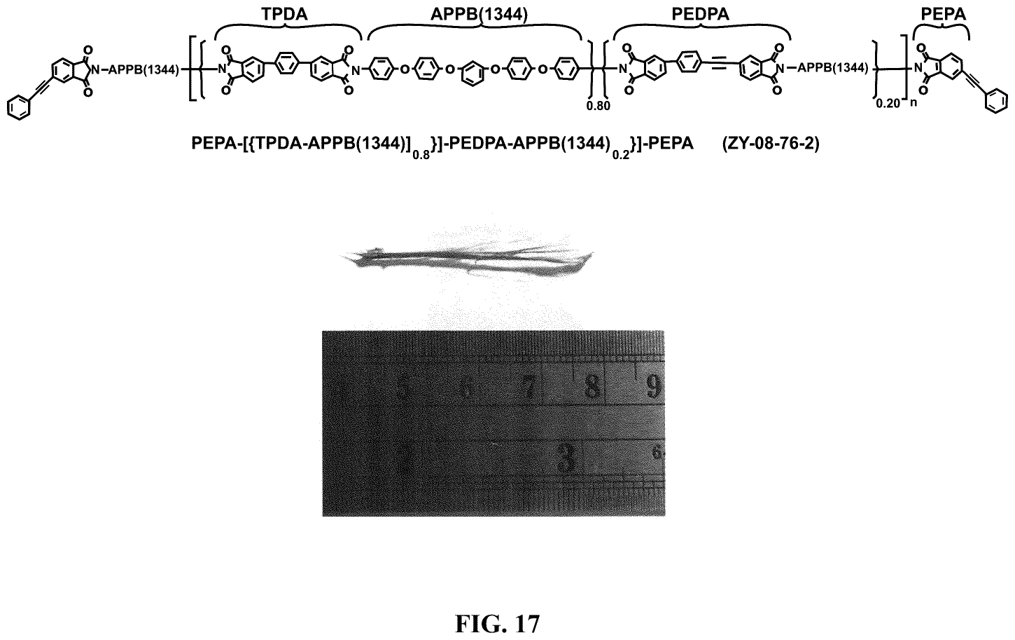

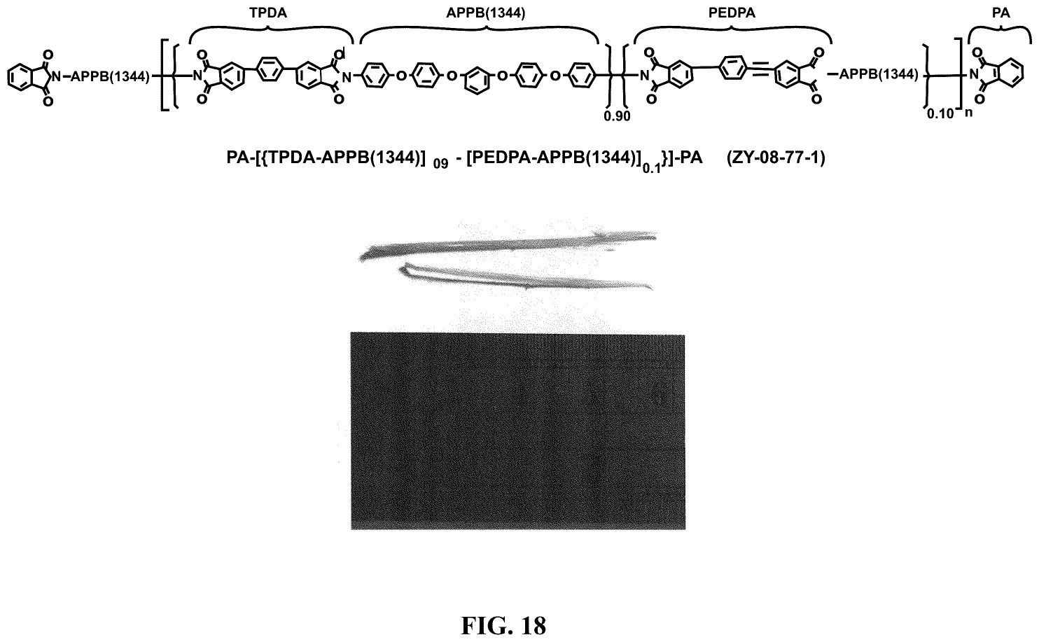

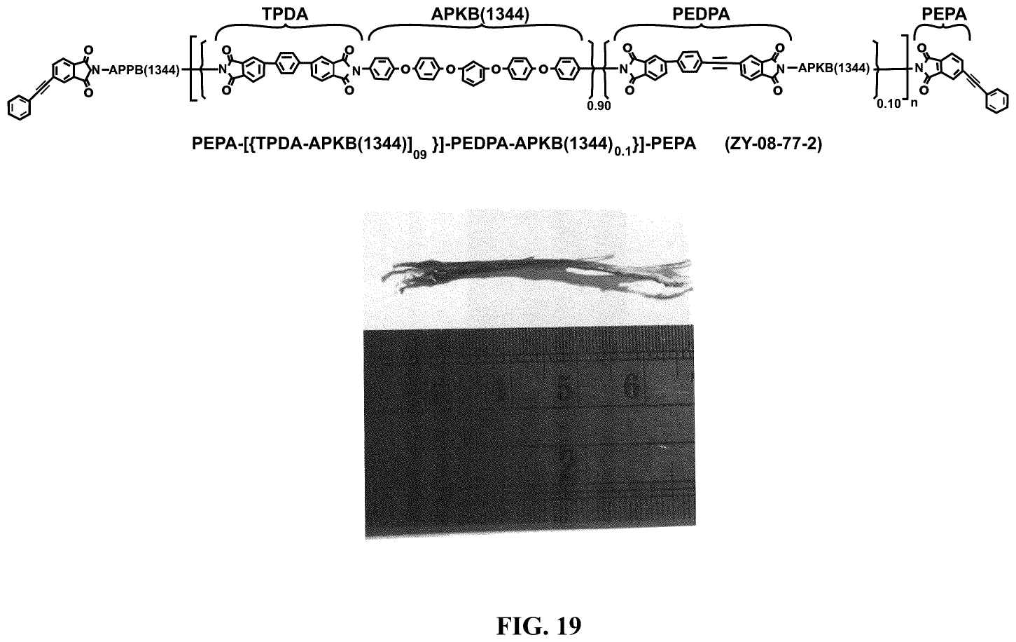

Fiber extrusion. The melt extrudability of both PA- and PEPA endcapped thermotropic [MPDA-L′(DPA)-co-MPDA-L″(DPA)] copolyimides is exemplified by fiber-forming capability of PA-[{TPDA-APPB(1344)]_{0.8}-[PEDPA-APPB(1344)]_{0.2}}]-PA (08-76-1), PEPA-[{TPDA-APPB(1344)]_{0.9}-[PEDPA-APPB(1344)]_{0.1}}]-PEPA (08-76-2), PA-[{TPDA-APPB(1344)]_{0.9}-[PEDPA-APPB(1344)]_{0.1}}]-PA (08-77-1), and PEPA-[{TPDA-APKB(1344)]_{0.9}-[PEDPA-APKB(1344)]_{0.1}}]-PEPA (08-77-2), by having fibers pulled from their melts as depicted in FIGS. 16-19. Qualitatively, the fibers are mechanically robust as they were pulled at the temperatures below that (>>300° C.) at which the main-chain phenylethynyl groups are expected to crosslinked in both samples.

### Crosslinkable, Low-Molecular-Weight, Main-Chain Thermotropic Liquid-Crystalline Co-Polyimides and Processes of Making and Using Same

For purposes of this specification, headings are not considered paragraphs. In this paragraph, Applicants disclose a copolymer having the following formula:

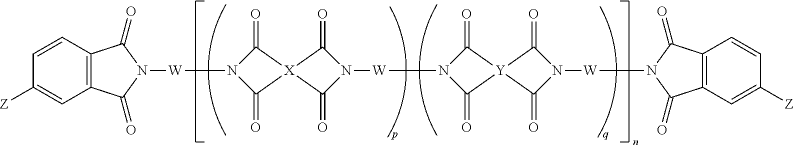

wherein
n is an integer from 1 to 100, preferably n is an integer from 4 to 20, more preferably n is an integer from 6 to 18;
each p is a value from the range 0.01-0.99; correspondingly, each q is a value from the range 0.99-0.01;
each W is identical and is selected from one of the following formula wherein m is 0 or 1

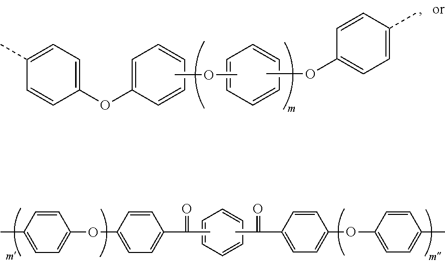

where m′=1 or 2 and m″=1 or 2; preferably both m′ and m″ are the same. all X moieties in said copolymer are identical, said X moieties having one of the two formula below wherein R is H Me, OMe, CN or F, preferably R is H, Me, OMe or F, more preferably R is H, Me or F, most preferably R is H or F:

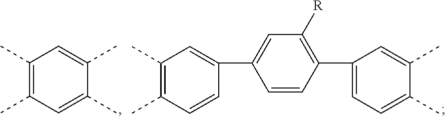

all Y moieties in said copolymer are identical, said Y moieties having one of the three formula below wherein R is H Me, OMe, CN or F, preferably R is H, Me, OMe or F, more preferably R is H, Me or F, most preferably R is H or F:

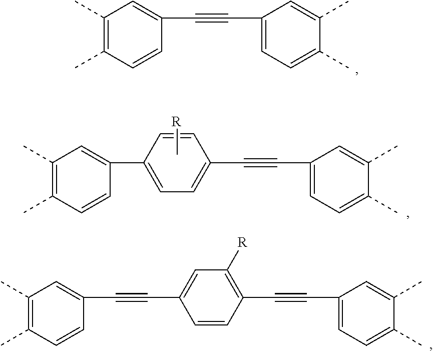

each Z is independently hydrogen or has the following structure

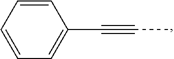

preferably each Z has the following structure

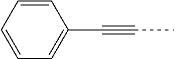

Applicants disclose the copolymer of the previous paragraph, said copolymer having a single glass transition temperature (Tg).

Applicants disclose the copolymer of the previous two paragraphs, wherein for the combined molar amount of X plus Y, the molar fraction of X is greater than zero but less than 1, preferably said molar fraction is from about 0.5 to about 0.99, more preferably said molar fraction is from about 0.8 to about 0.95.

### EXAMPLES

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

### Example 1: Synthesis of Copolyimide 08-76-1

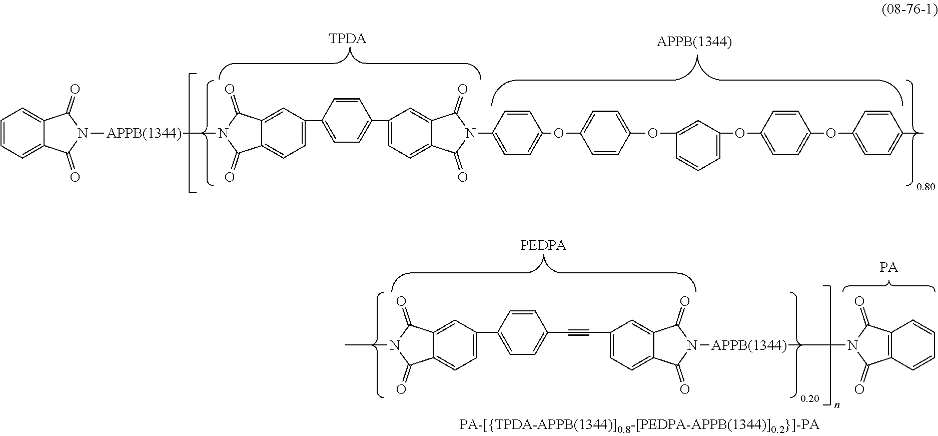

To a 100 mL round-bottomed flask equipped with nitrogen inlet, 1.0324 g (2.167 mmol) of 1,3-bis[4-(4-aminophenoxy)phenoxy)]benzene (APPB-1344) and 18 grams of 1-methyl-2-pyrrolidinone were charged. The mixture was stirred at room temperature until all solids were dissolved. Then, 157.7 mg (0.400 mmol) 4′-((3,4-dicarboxyphenyl)ethynyl)biphenyl -3,4-dicarboxylic acid dianhydride (IUPAC name: 5-(4-((1,3-dioxo-1,3-dihydroisobenzofuran-5-yl)ethynyl)phenyl)isobenzofuran-1,3-dione), PEDPA was charged. After 5 minutes, 0.5925 g (1.600 mmol) of [1,1′:4′,1″-terphenyl]-3,3″,4,4″-tetracarboxylic acid dianhydride (IUPAC name: 5,5′-(1,4-phenylene)diisobenzofuran-1,3-dione), TPDA was added. The solution of growing amic-acid copolymer was stirred at room temperature for 8 hours before 49.4 mg (0.333 mmol) of phthalic anhydride (PA) was added. The resulting mixture was further stirred for 16 hours at room temperature. Then, 2.0 mL pyridine and 2.4 ml acetic anhydride was added to effect the occurrence of the amic-acid-to-imide transformation. The final reaction mixture was stirred at room temperature for additional 24 hours. The mixture was poured into 2-propanol to precipitate the crude product, which was collected on a filtration funnel, washed with fresh 2-propanol and acetone, and finally air-dried. The final copolymer product was further dried at 130° C. in a vacuum oven at 0.5 torr for 24 hours.

### Example 2 Synthesis of Copolyimide 08-76-2

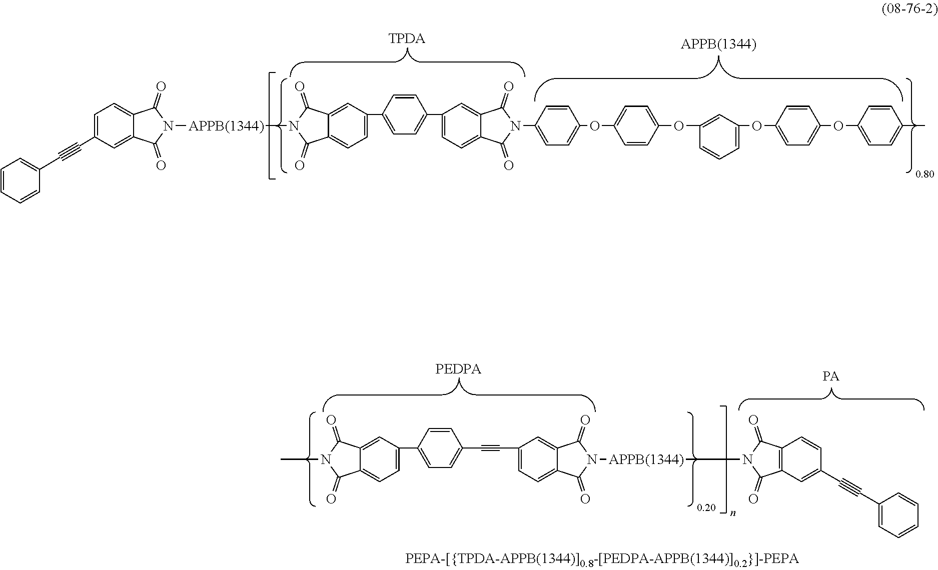

To a 100 mL round-bottomed flask equipped with nitrogen inlet, 1.0324 g (2.167 mmol) of 1,3-bis[4-(4-aminophenoxy)phenoxy)]benzene (1344-APPB) and 18 grams of 1-methyl-2-pyrrolidinone were charged. The mixture was stirred at room temperature until all solids were dissolved. 157.7 mg (0.400 mmol) of 4′-((3,4-dicarboxyphenyl)ethynyl)biphenyl-3,4-dicarboxylic acid dianhydride (IUPAC name: 5-(4-((1,3-dioxo-1,3-dihydroisobenzofuran-5-yl)ethynyl)phenyl)isobenzofuran-1,3-dione), PEDPA, was charged. After 5 minutes, 0.5925 g (1.600 mmol) of [1,1′:4′,1″-terphenyl]-3,3″,4,4″-tetracarboxylic acid dianhydride (IUPAC name: 5,5′-(1,4-phenylene)diisobenzofuran-1,3-dione), TPDA, was added. The mixture was stirred at room temperature for 8 hours before 82.7 mg (0.333 mmol) of 4-phenylethynylphthalic anhydride (PEPA) was added. The solution of growing amic-acid copolymer was further stirred for 16 hours at room temperature. Then, 2.0 mL pyridine and 2.4 ml acetic anhydride was added to effect the occurrence of the amic-acid-to-imide transformation. The final reaction mixture was stirred at room temperature for additional 24 hours. The mixture was poured into 2-propanol to precipitate the crude product, which was collected on a filtration funnel, washed with fresh 2-propanol and acetone, and finally air-dried. The final copolymer product was further dried at 130° C. in a vacuum oven at 0.5 torr for 24 hours.

### Example 3 Synthesis of Copolyimide 08-77-1

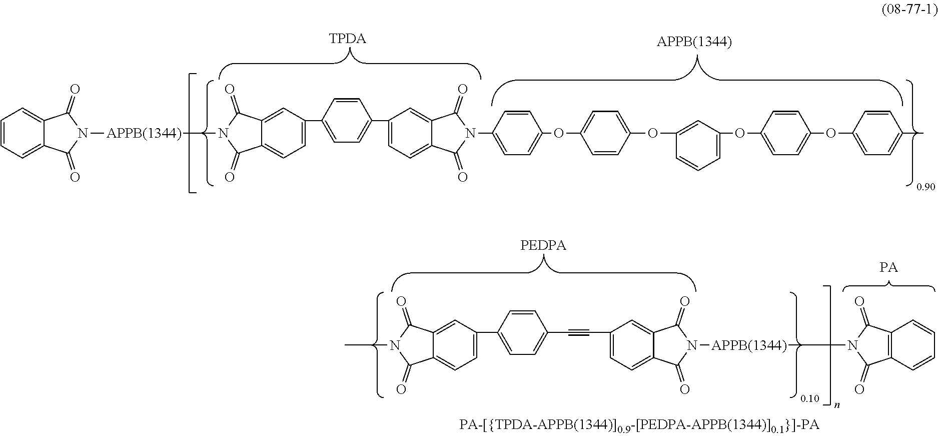

To a 100 mL round-bottomed flask equipped with nitrogen inlet, 1.0845 g (2.167 mmol) of 1,3-bis[4-(4-aminophenoxy)benzoyl]benzene (APPB-1344) and 18 grams of 1-methyl-2-pyrrolidinone were charged. The mixture was stirred at room temperature until all solids were dissolved. 78.9 mg (0.200 mmol) of 4′-((3,4-dicarboxyphenyl)ethynyl)biphenyl-3,4-dicarboxylic acid dianhydride (IUPAC name: 5-(4-((1,3-dioxo-1,3-dihydroisobenzofuran-5-yl)ethynyl)phenyl)isobenzofuran-1,3-dione), PEDPA, was charged. After 5 minutes, 0.6666 g (1.800 mmol) of [1,1′:4′,1″-terphenyl]-3,3″,4,4″-tetracarboxylic acid dianhydride (IUPAC name: 5,5′-(1,4-phenylene)diisobenzofuran-1,3-dione), TPDA was added. The solution of growing amic-acid copolymer was stirred at room temperature for 8 hours before 49.4 mg (0.333 mmol) of phthalic anhydride (PA) was added. The mixture was further stirred for 16 hours at room temperature. Then, 2.0 mL pyridine and 2.4 ml acetic anhydride was added to effect the occurrence of the amic-acid-to-imide transformation. The final reaction mixture was stirred at room temperature for additional 24 hours. The mixture was poured into 2-propanol to precipitate the crude product, which was collected on a filtration funnel, washed with fresh 2-propanol and acetone, and finally air-dried. The final copolymer product was further dried at 130° C. in a vacuum oven at 0.5 torr for 24 hours.

### Example 4 Synthesis of Copolyimide 08-77-2

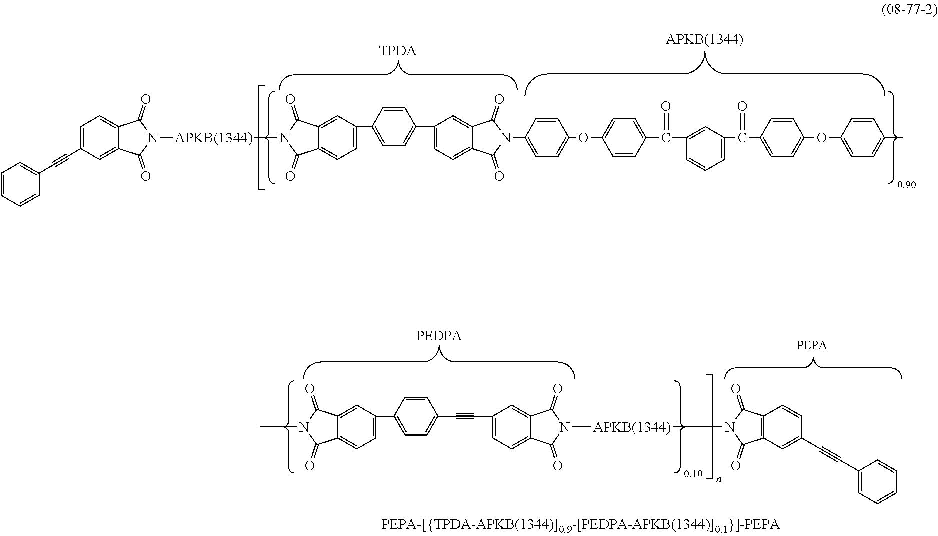

To a 100 mL round-bottomed flask equipped with nitrogen inlet, 1.0845 g (2.167 mmol) of 1,3-bis[4-(4-aminophenoxy)benzoyl]benzene (APKB-1344) and 18 grams of 1-methyl-2-pyrrolidinone were charged. The mixture was stirred at room temperature until all solids were dissolved. 78.9 mg (0.200 mmol) of 4′-((3,4-dicarboxyphenyl)ethynyl)biphenyl-3,4-dicarboxylic acid dianhydride (IUPAC name: 5-(4-((1,3-dioxo-1,3-dihydroisobenzofuran-5-yl)ethynyl)phenyl)isobenzofuran-1,3-dione), PEDPA was charged. After 5 minutes, 0.666 g (1.800 mmol) of [1,1′:4′,1″-terphenyl]-3,3″,4,4″-tetracarboxylic acid dianhydride (IUPAC name: 5,5′-(1,4-phenylene)diisobenzofuran-1,3-dione), TPDA was added. The solution of growing amic-acid copolymer was stirred at room temperature for 8 hours before 82.7 mg (0.333 mmol) of 4-phenylethynylphthalic anhydride (PEPA) was added. The mixture was further stirred for 16 hours at room temperature. Then, 2.0 mL pyridine and 2.4 ml acetic anhydride was added to effect the occurrence of the amic-acid-to-imide transformation. The final reaction mixture was stirred at room temperature for additional 24 hours. The mixture was poured into 2-propanol to precipitate the crude product, which was collected on a filtration funnel, washed with fresh 2-propanol and acetone, and finally air-dried. The final copolymer product was further dried at 130° C. in a vacuum oven at 0.5 torr for 24 hours.

### Example 5 Synthesis of Copolyimide 08-79-1

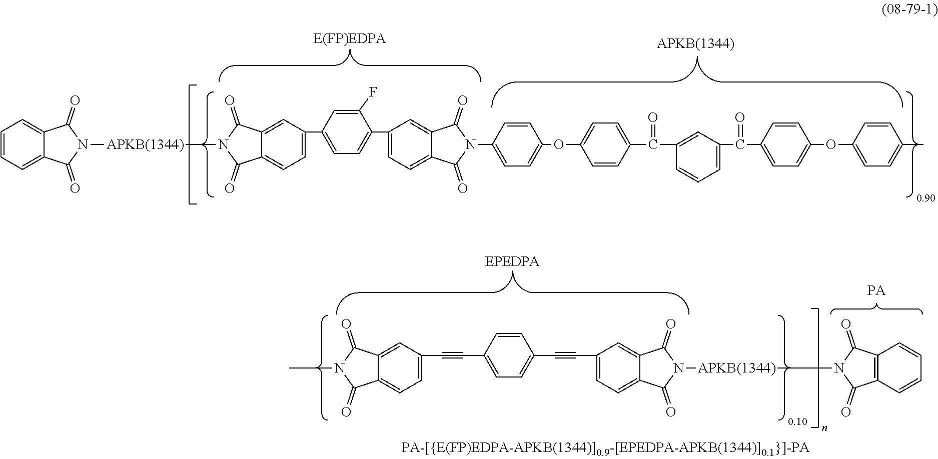

To a 100 mL round-bottomed flask equipped with nitrogen inlet, 1.0845 g (2.167 mmol) of 1,3-bis[4-(4-aminophenoxy)benzoyl]benzene (APKB-1344) and 18 grams of 1-methyl-2-pyrrolidinone were charged. The mixture was stirred at room temperature until all solids were dissolved. 83.7 mg (0.200 mmol) of 4′-((4,4′-(1,4-phenylenebis(ethyne-2,1-diyl))diphthalic anhydride (IUPAC name: 5,5′-(1,4-phenylenebis(ethyne-2,1-diyl))diisobenzofuran-1,3-dione). 1,4EPE-DPA, was charged. After 5 minutes, 0.7950 g (1.800 mmol) of 4,4′-(2-fluoro-1,4-phenylene)bis(ethyne-2,1-diyl)diphthalic anhydride (IUPAC name: 5,5′-(2-fluoro-1,4-phenylene)bis(ethyne-2,1-diyl)diisobenzofuran-1,3-dione), 14E(FP)E-DPA was added. The solution of growing amic-acid copolymer was stirred at room temperature for 8 hours before 49.4 mg (0.333 mmol) of phthalic anhydride (PA) was added. The mixture was further stirred for 16 hours at room temperature. Then, 2.0 mL pyridine and 2.4 ml acetic anhydride was added to effect the occurrence of the amic-acid-to-imide transformation. The final reaction mixture was stirred at room temperature for additional 24 hours. The mixture was poured into 2-propanol to precipitate the crude product, which was collected on a filtration funnel, washed with fresh 2-propanol and acetone, and finally air-dried. The final copolymer product was further dried at 130° C. in a vacuum oven at 0.5 torr for 24 hours.

### Example 6 Synthesis of Copolyimide 08-79-2

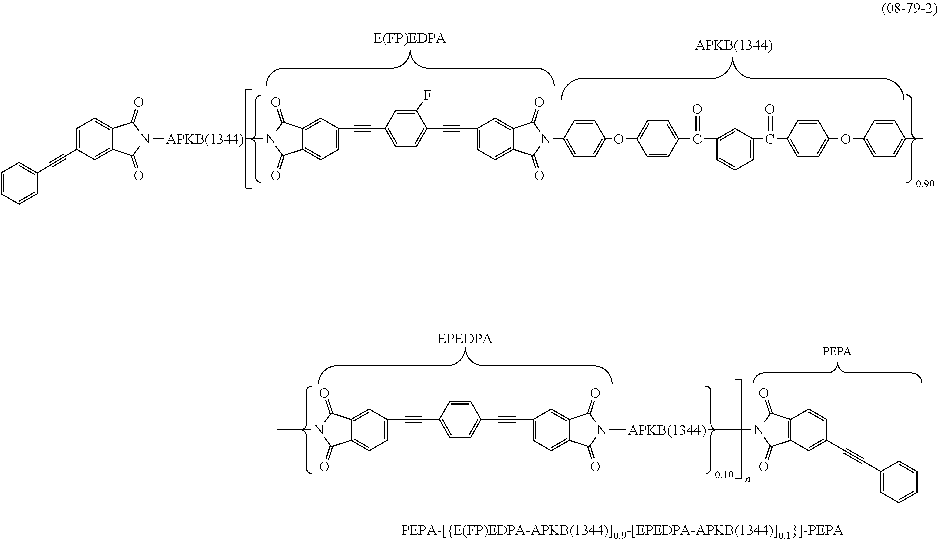

To a 100 mL round-bottomed flask equipped with nitrogen inlet, 1.0845 g (2.167 mmol) of 1,3-bis[4-(4-aminophenoxy)benzoyl]benzene (APKB-1344) and 18 grams of 1-methyl-2-pyrrolidinone were charged. The mixture was stirred at room temperature until all solids were dissolved. Then, 83.7 mg (0.200 mmol) of 4′-((4,4′-(1,4-phenylenebis(ethyne-2,1-diyl))diphthalic anhydride (IUPAC name: 5,5′-(1,4-phenylenebis(ethyne-2,1-diyl))diisobenzofuran-1,3-dione). 1,4EPE-DPA, was charged. After 5 minutes. 0.7950 g (1.800 mmol) of 4,4′-(2-fluoro-1,4-phenylene)bis(ethyne-2,1-diyl)diphthalic anhydride (IUPAC name: 5,5′-(2-fluoro-1,4-phenylene)bis(ethyne-2,1-diyl)diisobenzofuran-1,3-dione), 14E(FP)E-DPA, was added. The solution of growing amic-acid copolymer was stirred at room temperature for 8 hours before 82.7 mg (0.333 mmol) of 4-phenylethynylphthalic anhydride (PEPA) was added. The mixture was further stirred for 16 hours at room temperature. Then, 2.0 mL pyridine and 2.4 ml acetic anhydride was added to effect the occurrence of the amic-acid-to-imide transformation. The final reaction mixture was stirred at room temperature for additional 24 hours. The mixture was poured into 2-propanol to precipitate the crude product, which was collected on a filtration funnel, washed with fresh 2-propanol and acetone, and finally air-dried. The final copolymer product was further dried at 130° C. in a vacuum oven at 0.5 torr for 24 hours.

### Example 7 Synthesis of Copolyimide 08-80-1

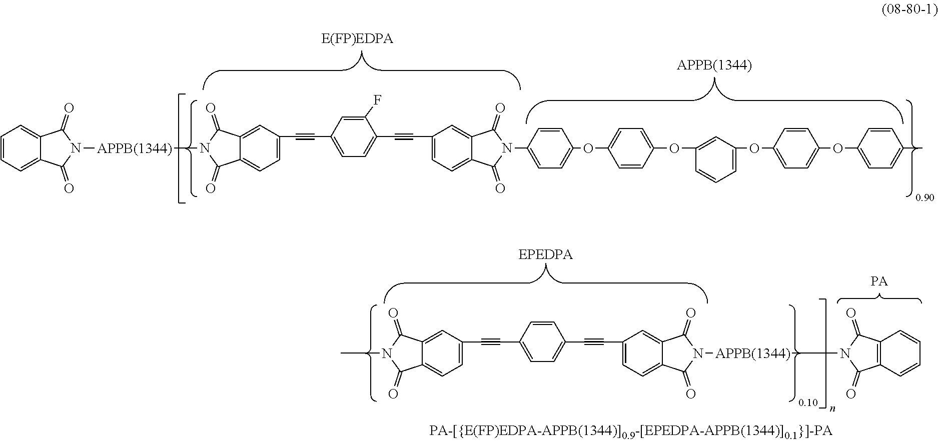

To a 100 mL round-bottomed flask equipped with nitrogen inlet, 1.0324 g (2.167 mmol) of 1,3-bis[4-(4-aminophenoxy)phenoxy)]benzene (APPB-1344) and 18 grams of 1-methyl-2-pyrrolidinone were charged. The mixture was stirred at room temperature until all solids were dissolved. Then, 83.7 mg (0.200 mmol) of 4′-((4,4′-(1,4-phenylenebis(ethyne-2,1-diyl))diphthalic anhydride (IUPAC name: 5,5′-(1,4-phenylenebis(ethyne-2,1-diyl))diisobenzofuran-1,3-dione). 1,4EPE-DPA, was charged. After 5 minutes, 0.7950 g (1.800 mmol) of 4,4′-(2-fluoro-1,4-phenylene)bis(ethyne-2,1-diyl)diphthalic anhydride (IUPAC name: 5,5′-(2-fluoro-1,4-phenylene)bis(ethyne-2,1-diyl)diisobenzofuran-1,3-dione), 14E(FP)E-DPA, was added. The mixture was stirred at room temperature for 8 hours before 49.4 mg (0.333 mmol) of phthalic anhydride (PA) was added. The solution of growing amic-acid copolymer was further stirred for 16 hours at room temperature. Then, 2.0 mL of pyridine and 2.4 mL of acetic anhydride was added to effect the occurrence of the amic-acid-to-imide transformation. The final reaction mixture was stirred at room temperature for additional 24 hours. The mixture was poured into 2-propanol to precipitate the crude product, which was collected on a filtration funnel, washed with fresh 2-propanol and acetone, and finally air-dried. The final copolymer product was further dried at 130° C. in a vacuum oven at 0.5 torr for 24 hours.

### Example 8 Synthesis of Copolyimide 08-80-2

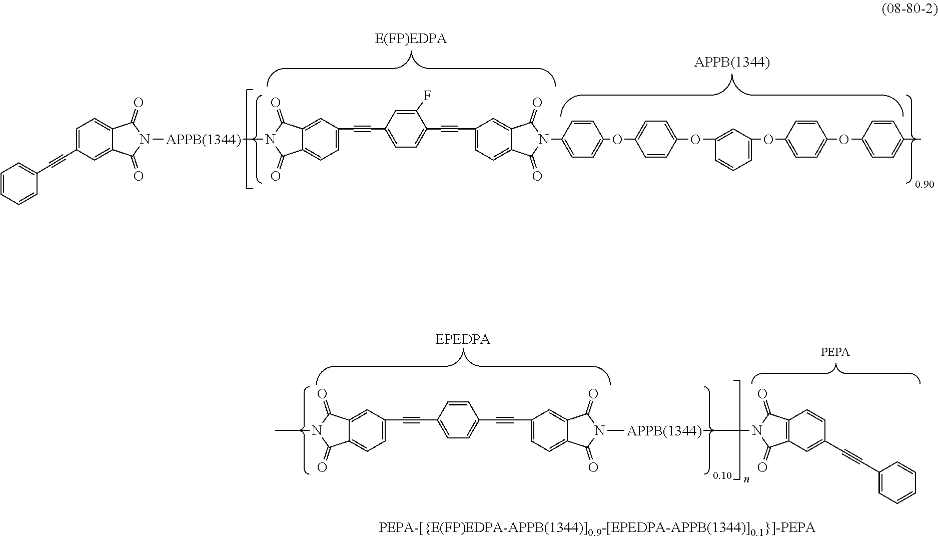

To a 100 mL round-bottomed flask equipped with nitrogen inlet, 1.0324 g (2.167 mmol) of 1,3-bis[4-(4-aminophenoxy)phenoxy)]benzene (APPB-1344) and 18 grams of 1-methyl-2-pyrrolidinone were charged. The mixture was stirred at room temperature until all solids were dissolved. Then, 83.7 mg (0.200 mmol) 4′-((4,4′-(1,4-phenylenebis(ethyne-2,1-diyl))diphthalic anhydride (IUPAC name: 5,5′-(1,4-phenylenebis(ethyne-2,1-diyl))diisobenzofuran-1,3-dione). 1,4EPE-DPA, was charged. After 5 minutes, 0.7950 g (1.800 mmol) of 4,4′-(2-fluoro-1,4-phenylene)bis(ethyne-2,1-diyl)diphthalic anhydride (IUPAC name: 5,5′-(2-fluoro-1,4-phenylene)bis(ethyne-2,1-diyl)diisobenzofuran-1,3-dione), 14E(FP)E-DPA, was added. The solution of growing amic-acid copolymer was stirred at room temperature for 8 hours before 82.7 mg (0.333 mmol) of 4-phenylethynylphthalic anhydride (PEPA) was added. The mixture was further stirred for 16 hours at room temperature. Then, 2.0 mL of pyridine and 2.4 mL of acetic anhydride was added to effect the occurrence of the amic-acid-to-imide transformation. The final reaction mixture was stirred at room temperature for additional 24 hours. The mixture was poured into 2-propanol to precipitate the crude product, which was collected on a filtration funnel, washed with fresh 2-propanol and acetone, and finally air-dried. The final copolymer product was further dried at 130° C. in a vacuum oven at 0.5 ton for 24 hours.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and process, and illustrative examples shown and described. Accordingly, departures may be made from such details without departing from the scope of the general inventive concept.

What is claimed is:

1. A copolymer having the following formula: 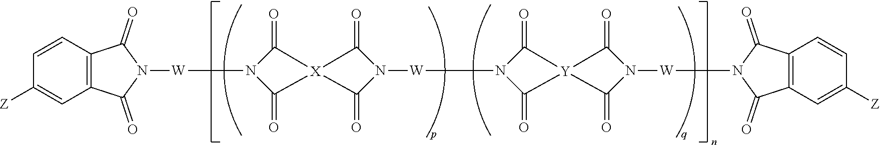
wherein
n is an integer from 1 to 100;
each p is a value from the range 0.01-0.99; correspondingly, each q is a value from the range 0.99-0.01;
each W is identical and is selected from one of the following formula wherein m is 0 or 1 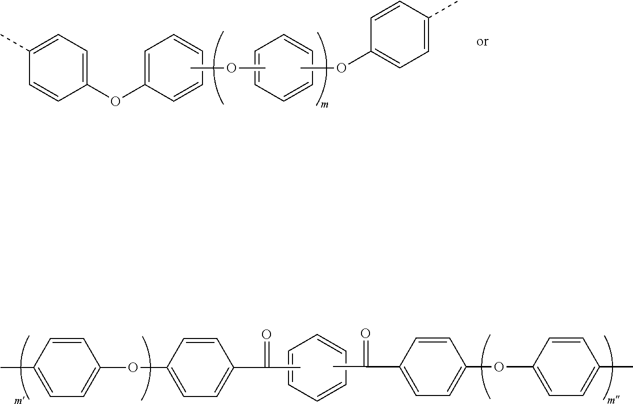
where m′=1 or 2 and m″=1 or 2;
all X moieties in said copolymer are identical, said X moieties having one of the two formula below wherein R is H Me, OMe, CN or F: 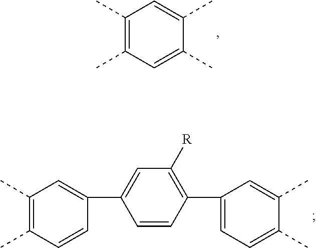
all Y moieties in said copolymer are identical, said Y moieties having one of the three formula below wherein R is H Me, OMe, CN or F: 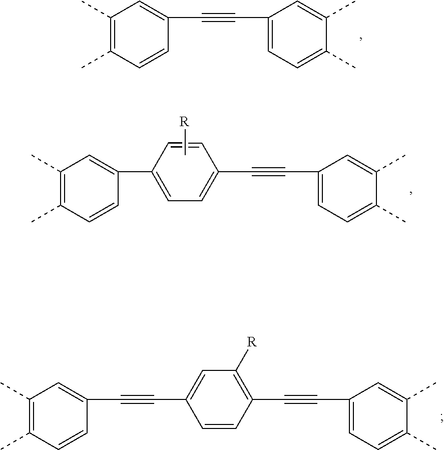
each Z is independently hydrogen or has the following structure 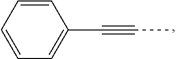
preferably each Z has the following structure

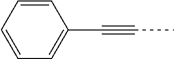

2. The copolymer of claim 1, said copolymer having a single glass transition temperature (Tg).

3. The copolymer of claim 1, wherein m′ and m″ are identical.

4. The copolymer of claim 1, wherein for X, R is H, Me, OMe or F and for Y, R is H, Me, OMe or F.

5. The copolymer of claim 4, wherein for X, R is H, Me or F and for Y, R is H, Me or F.

6. The copolymer of claim 4, wherein for X, R is H or F and for Y, R is H or F.

7. The copolymer of claim 1 wherein for the combined molar amount of X plus Y, the molar fraction of X is greater than zero but less than 1.

8. The copolymer of claim 7 wherein said molar fraction is from about 0.5 to about 0.99.

9. The copolymer of claim 8 wherein said molar fraction is from about 0.8 to about 0.95.

10. The copolymer of claim 1 wherein n is an integer from 4 to 20.

11. The copolymer of claim 10 wherein n is an integer from 6 to 18.
